(19) United States
(12) Patent Application Publication
(10) Pub. No.: US 2015/0221169 A1
(43) Pub. Date: Aug. 6, 2015

(54) GAMING SYSTEM AND METHOD PROVIDING A SECONDARY GAME HAVING A VARYING NARRATIVE BASED ON A SECONDARY GAME PROGRESS

(71) Applicant: IGT, Las Vegas, NV (US)

(72) Inventor: Cameron A. Filipour, Las Vegas, NV (US)

(21) Appl. No.: 14/169,869

(22) Filed: Jan. 31, 2014

(51) Int. Cl. G07F 17/32

(52) U.S. Cl. CPC G07F 17/3244; G07F 17/3211

(57) ABSTRACT

Various embodiments of the present disclosure provide a gaming system and method providing a secondary game having a varying narrative based on secondary game progress. In various embodiments, the gaming system enables a player to play a primary game in association with the secondary game. The secondary game progresses based at least in part on certain events that randomly occur during play of the primary game. The secondary game includes a narrative or storyline that unfolds or develops (such as through the display of video segments) based at least in part on the player's progress in the secondary game. Since the secondary game progresses based on play of the primary game, the gaming system leverages the random nature of the primary game to provide an unpredictable secondary game narrative that is nevertheless linked to the player's progress in the secondary game to maintain player interest in the secondary game.

### COPYRIGHT NOTICE

A portion of the disclosure of this patent document contains or may contain material that is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Gaming systems that provide players awards in primary or base games are well known. These gaming systems generally require a player to place a wager to activate a play of the primary game. For many of these gaming systems, any award provided to a player for a wagered-on play of a primary game is based on the player obtaining a winning symbol or a winning symbol combination and on an amount of the wager (e.g., the higher the amount of the wager, the higher the award). Winning symbols or winning symbol combinations that are less likely to occur typically result in larger awards being provided when they do occur.

For such known gaming systems, an amount of a wager placed on a primary game by a player may vary. For instance, a gaming system may enable a player to wager a minimum quantity of credits, such as one credit (e.g., in monetary currency, one penny, nickel, dime, quarter, or dollar; in non-monetary currency, one point, credit, coin, token, free play credit, or virtual buck), up to a maximum quantity of credits, such as five credits. The gaming system may enable the player to place this wager a single time or multiple times for a single play of the primary game. For instance, a gaming system configured to operate a slot game may have one or more paylines, and the gaming system may enable a player to place a wager on each of the paylines for a single play of the slot game. Thus, it is known that a gaming system, such as one configured to operate a slot game, may enable players to place wagers of substantially different amounts on each play of a primary game. For example, the amounts of the wagers may range from one credit up to 125 credits (e.g., five credits on each of twenty-five separate paylines). This is also true for other wagering games, such as video draw poker, in which players can place wagers of one or more credits on each hand, and in which multiple hands can be played simultaneously. Accordingly, it should be appreciated that different players play at substantially different wager amounts or levels and substantially different rates of play.

Bonus or secondary games are also known in gaming systems. Such gaming systems usually provide an award to a player for a play of one such bonus game in addition to any awards provided for any plays of any primary games. Bonus games usually do not require an additional wager to be placed by the player to be initiated. Bonus games are typically initiated or triggered upon an occurrence of a designated triggering symbol or designated triggering symbol combination in the primary game. For instance, a gaming system may initiate or trigger a bonus game when a bonus symbol occurs on the payline on the third reel of a three reel slot machine. The gaming systems generally indicates when a bonus game is initiated or triggered through one or more visual and/or audio output devices, such as the reels, lights, speakers, display screens, etc. Part of the enjoyment and excitement of playing certain gaming systems is the initiation or triggering of a bonus game, even before the player knows an amount of a bonus award won via the bonus game.

Various players continually seek out new and different variations to gaming systems. A continuing need thus exists for gaming systems and methods that provide new, exciting, and engaging games.

### SUMMARY

Various embodiments of the present disclosure provide a gaming system and method providing a secondary game having a varying narrative based on secondary game progress.

In various embodiments, the gaming system enables a player to play a primary game in association with the secondary game. The secondary game progresses based at least in part on certain events that randomly occur during play of the primary game. The secondary game includes a narrative or storyline that unfolds or develops (such as through the display of video segments) based at least in part on the player's progress in the secondary game. Since the secondary game progresses based on play of the primary game, the gaming system leverages the random nature of the primary game to provide an unpredictable secondary game narrative that is nevertheless linked to the player's progress in the secondary game to maintain player interest in the secondary game.

More specifically, in operation of one embodiment, the gaming system displays a secondary game including a plurality of object visitation areas and a secondary game object. Upon a random occurrence of a secondary game object movement event during play of a primary game, the gaming system moves the secondary game object to an at least partially randomly determined one of the object visitation areas. Upon a random occurrence of a secondary game story event during play of the primary game, the gaming system determines one of a plurality of different video segments that will begin, continue, or conclude a current narrative of the secondary game, and displays the determined video segment.

The gaming system determines the video segment based on a variety of different factors, such as the object visitation area that the secondary game object is currently visiting in the secondary game and any previously-displayed video segments for the current narrative of the secondary game. It should thus be appreciated that since the gaming system determines which particular video segment to display based on a plurality of different factors (some of which are based on play of the primary game), the gaming system is likely to determine and display different video segments or different combinations of video segments each time a player plays the secondary game. The ability of the gaming system to determine video segments and combinations of video segments to tailor the narrative of the secondary game to the particular instance of the secondary game being played, which is itself affected by the random nature of the primary game, thus provides a secondary game that may be different each time a player plays the secondary game, which reduces or eliminates the potential for monotony or repetitiveness.

Further, in this embodiment, certain events that occur in the secondary game cause the gaming system to change one or more aspects of the primary game. More specifically, in this embodiment, each object visitation area has or is otherwise associated with one of a plurality of different primary themes. The gaming system employs the primary theme of the object visitation area that the secondary game character is visiting at a particular point in time as the current primary theme of the primary game. Put differently, the object visitation area currently being visited by the secondary game object controls the current primary theme of the primary game.

It should thus be appreciated that the gaming system and method of the present disclosure increase player engagement, enjoyment, entertainment, and excitement.

Additional features and advantages are described herein, and will be apparent from, the following Detailed Description and the Figures.

### BRIEF DESCRIPTION OF THE FIGURES

FIGS. 1A and 1B illustrate a flowchart illustrating an example method of operating one embodiment of the gaming system of the present disclosure.

FIGS. 2A, 2B, 2C, 2D, 2E, 2F 2G, 2H, 2I, 2J, 2K, and 2L illustrate screen shots of one example embodiment of the gaming system of the present disclosure operating a primary slot game and a secondary game.

FIG. 3A is a schematic block diagram of one embodiment of a network configuration of the gaming system of the present disclosure.

FIG. 3B is a schematic block diagram of an example electronic configuration of the gaming system of the present disclosure.

FIGS. 4A and 4B are perspective views of example alternative embodiments of the gaming system of the present disclosure.

### DETAILED DESCRIPTION

Secondary Game Having a Varying Narrative Based on Secondary Game Progress

Various embodiments of the present disclosure provide a gaming system and method providing a secondary game having a varying narrative based on secondary game progress.

In various embodiments, the gaming system enables a player to play a primary game in association with the secondary game. The secondary game progresses based at least in part on certain events that randomly occur during play of the primary game. The secondary game includes a narrative or storyline that unfolds or develops (such as through the display of video segments) based at least in part on the player's progress in the secondary game. Since the secondary game progresses based on play of the primary game, the gaming system leverages the random nature of the primary game to provide an unpredictable secondary game narrative that is nevertheless linked to the player's progress in the secondary game to maintain player interest in the secondary game.

More specifically, in operation of one embodiment, the gaming system displays a secondary game including a plurality of object visitation areas and a secondary game object. Upon a random occurrence of a secondary game object movement event during play of a primary game, the gaming system moves the secondary game object to an at least partially randomly determined one of the object visitation areas. Upon a random occurrence of a secondary game story event during play of the primary game, the gaming system determines one of a plurality of different video segments that will begin, continue, or conclude a current narrative of the secondary game, and displays the determined video segment.

The gaming system determines the video segment based on a variety of different factors, such as the object visitation area that the secondary game object is currently visiting in the secondary game and any previously-displayed video segments for the current narrative of the secondary game. It should thus be appreciated that since the gaming system determines which particular video segment to display based on a plurality of different factors (some of which are based on play of the primary game), the gaming system is likely to determine and display different video segments or different combinations of video segments each time a player plays the secondary game. The ability of the gaming system to determine video segments and combinations of video segments to tailor the narrative of the secondary game to the particular instance of the secondary game being played, which is itself affected by the random nature of the primary game, thus provides a secondary game that may be different each time a player plays the secondary game, which reduces or eliminates the potential for monotony or repetitiveness.

Further, in this embodiment, certain events that occur in the secondary game cause the gaming system to change one or more aspects of the primary game. More specifically, in this embodiment, each object visitation area has or is otherwise associated with one of a plurality of different primary themes. The gaming system employs the primary theme of the object visitation area that the secondary game character is visiting at a particular point in time as the current primary theme of the primary game. Put differently, the object visitation area currently being visited by the secondary game object controls the current primary theme of the primary game.

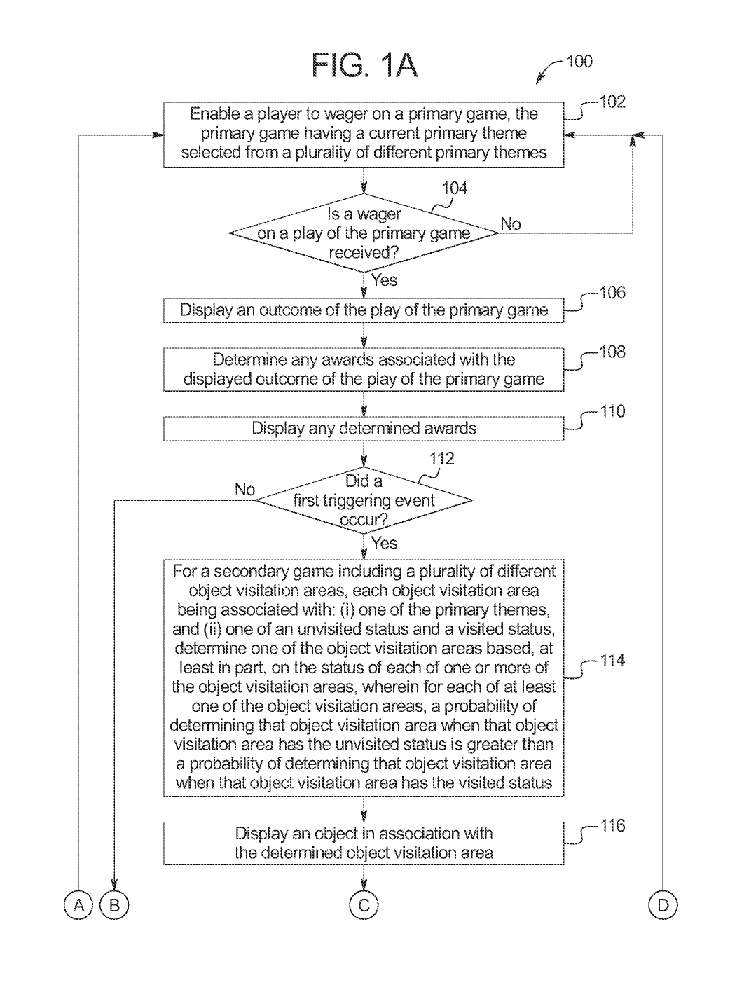

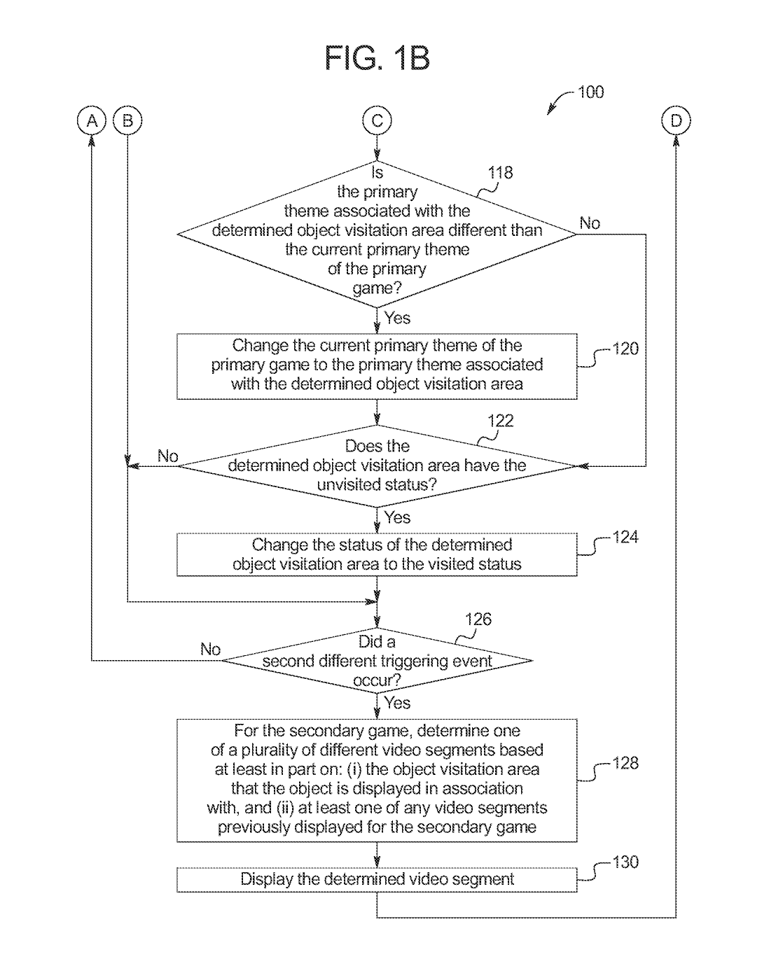

FIGS. 1A and 1B illustrate a flowchart of an example process or method 100 of operating one embodiment of the gaming system of the present disclosure. In various embodiments, the process 100 is represented by a set of instructions stored in one or more memories and executed by one or more processors. Although the process 100 is described with reference to the flowchart shown in FIGS. 1A and 1B, it should be appreciated that many other processes of performing the acts associated with this illustrated process 100 may be employed. For example, the order of certain of the illustrated blocks and/or diamonds may be changed, certain of the illustrated blocks and/or diamonds may be optional, and/or certain of the illustrated blocks and/or diamonds may not be employed.

In operation of this example embodiment, the gaming system enables a player to wager on a primary game, as indicated by block 102. The primary game has or is otherwise associated with a current primary theme that is one of a plurality of different primary themes. The gaming system determines whether a wager on a play of the primary game has been received, as indicated by diamond 104. If the gaming system determines that a wager on a play of the primary game has not been received, the process 100 returns to the block 102. If, on the other hand, the gaming system determines that a wager on a play of the primary game has been received, the gaming system: (a) displays an outcome of the play of the primary game, as indicated by block 106; (b) determines any awards associated with the displayed outcome of the play of the primary game, as indicated by block 108; and (c) displays any determined awards, as indicated by block 110.

The gaming system determines whether a first triggering event occurred, as indicated by block 112. If the gaming system determines that the first triggering event did not occur, the process 100 proceeds to diamond 126, described below. If, on the other hand, the gaming system determines that the first triggering event occurred, for a secondary game including a plurality of different object visitation areas, each object visitation area being associated with: (a) one of the primary themes, and (b) one of an unvisited status and a visited status, the gaming system determines one of the object visitation areas based, at least in part, on the status of each of one or more of the object visitation areas, as indicated by block 114. Put differently, in this example embodiment, upon an occurrence of the first triggering event, the gaming system determines one of the object visitation areas of the secondary game based at least in part on whether each of one or more of the object visitation areas has the visited status or the unvisited status.

In this example embodiment, for each of at least one of the object visitation areas of the secondary game, a probability of the gaming system determining that object visitation area when that object visitation area has the unvisited status is greater than a probability of the gaming system determining that object visitation area when that object visitation area has the visited status. That is, in this example embodiment, for a particular object visitation area, the gaming system is more likely to determine that particular object visitation area when that particular object visitation area has the unvisited status than when that particular object visitation area has the visited status.

After determining one of the object visitation areas of the secondary game, the gaming system displays an object in association with the determined object visitation area, as indicated by block 116. The gaming system determines if the primary theme associated with the determined object visitation area is different than the current primary theme of the primary game, as indicated by diamond 118. If the gaming system determines that the primary theme associated with the determined object visitation area is the same as (i.e., is not different than) the current primary theme of the primary game, the process 100 proceeds to the diamond 122, described below. If, on the other hand, the gaming system determines that the primary theme associated with the determined object visitation area is different than the current primary theme of the primary game, the gaming system changes the current primary theme of the primary game to the primary theme associated with the determined object visitation area, as indicated by block 124. It should thus be appreciated that, in this example embodiment, the object visitation area of the secondary game that the object is displayed in association with controls or determines which of the primary themes the gaming system employs as the current primary theme of the primary game.

The gaming system determines whether the determined object visitation area has the unvisited status, as indicated by the diamond 122. If the gaming system determines that the determined object visitation area does not have the unvisited status (i.e., determines that the determined object visitation area has the visited status in this example embodiment), the process 100 proceeds to the diamond 126, described below. If, on the other hand, the gaming system determines that the determined object visitation area has the unvisited status, the gaming system changes the status of the determined object visitation area to the visited status, as indicated by block 124.

The gaming system determines whether a second triggering event occurs, as indicated by the diamond 126. In this example embodiment, the second triggering event is different than the first triggering event. If the gaming system determines that the second triggering event did not occur, the process 100 returns to the block 102. If, on the other hand, the gaming system determines that the second triggering event occurred, for the secondary game, the gaming system determines one of a plurality of different video segments based at least in part on: (a) the object visitation area that the object is displayed in association with, and (b) at least one of any video segments previously displayed for the secondary game, as indicated by block 128. The gaining system displays the determined video segment, as indicated by block 130. The process 100 returns to the block 102.

It should be appreciated that the current primary theme of the primary game may manifest itself in one or more of a plurality of different manners, such as (but not limited to): (a) when the primary game is a slot game, the symbols on the reels are associated with the current primary theme; (b) when the primary game is a card game, at least one aspect of the cards (such as the card backs) is associated with the current primary theme; (c) the background of the primary game is associated with the current primary theme; (d) one or more sound effects of the primary game are associated with the current primary theme; (e) one or more bonus games that may be triggered in association with the primary game are associated with the current primary theme; (f) one or more video segments displayed in association with the primary game are associated with the current primary theme; (g) one or more still images displayed in association with the primary game are associated with the current primary theme; (h) one or more awards that a player may win in association with the primary game are associated with the current primary theme; and/or (i) one or more advertisements or promotions displayed in association with the primary game are associated with the current primary theme.

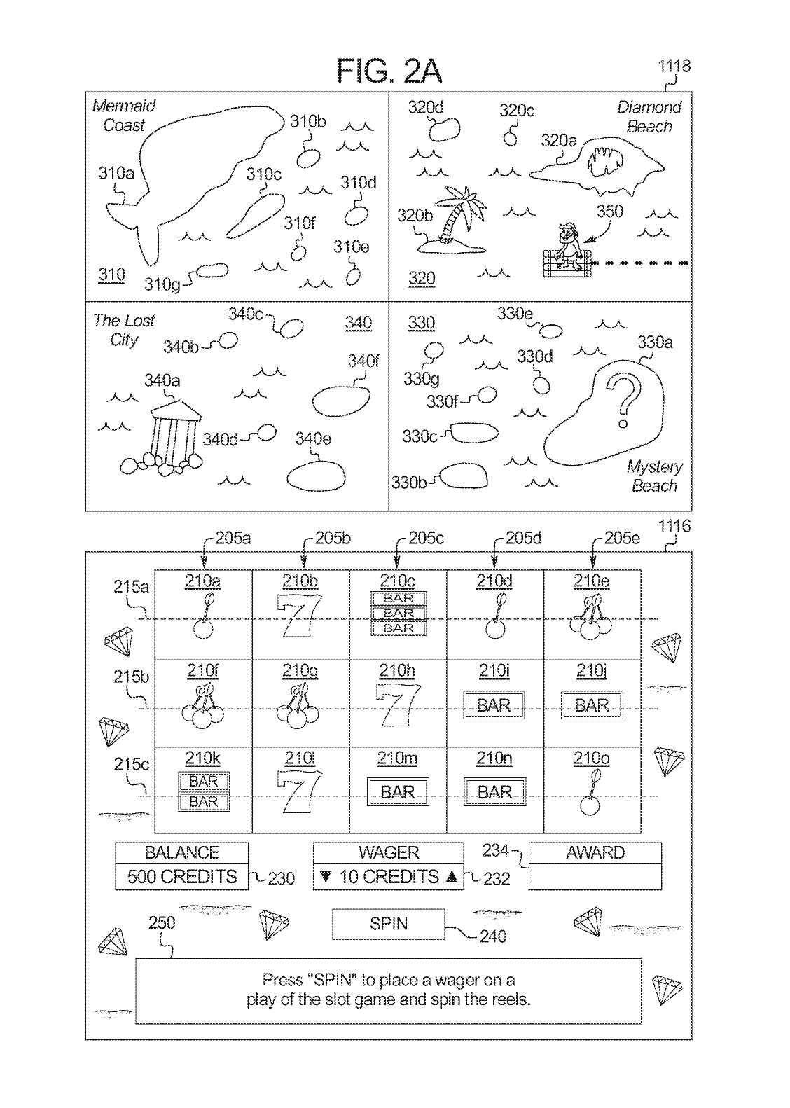

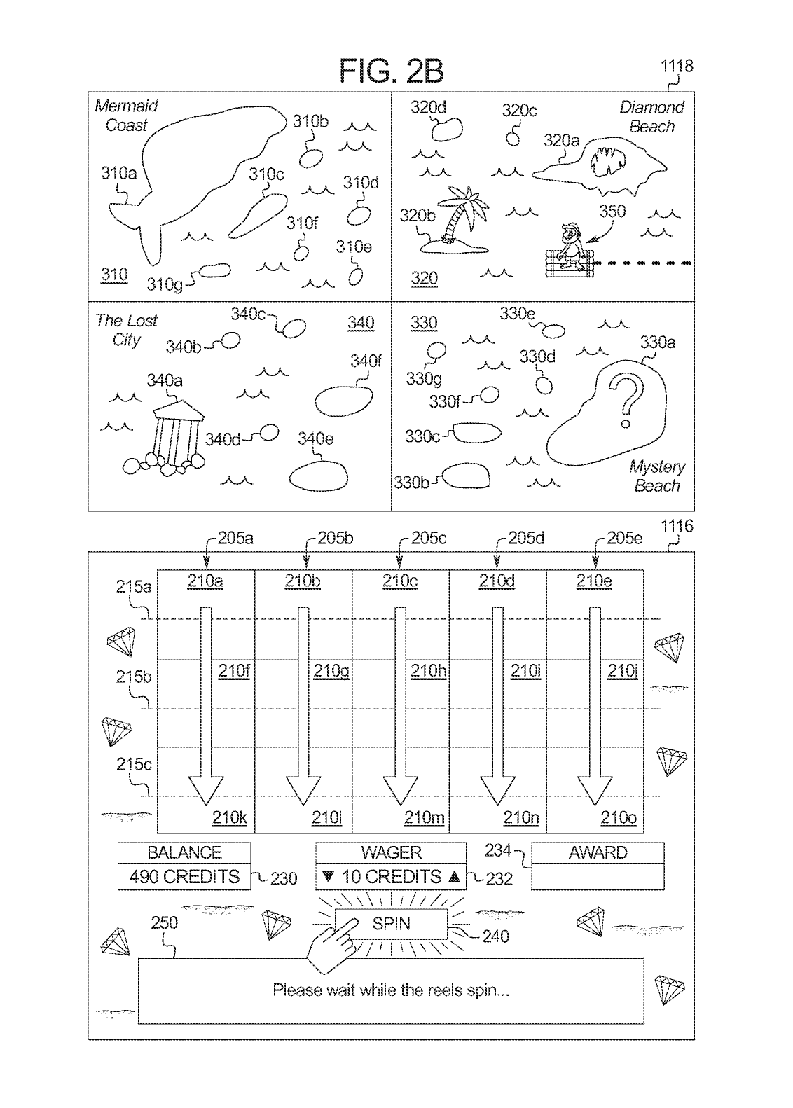

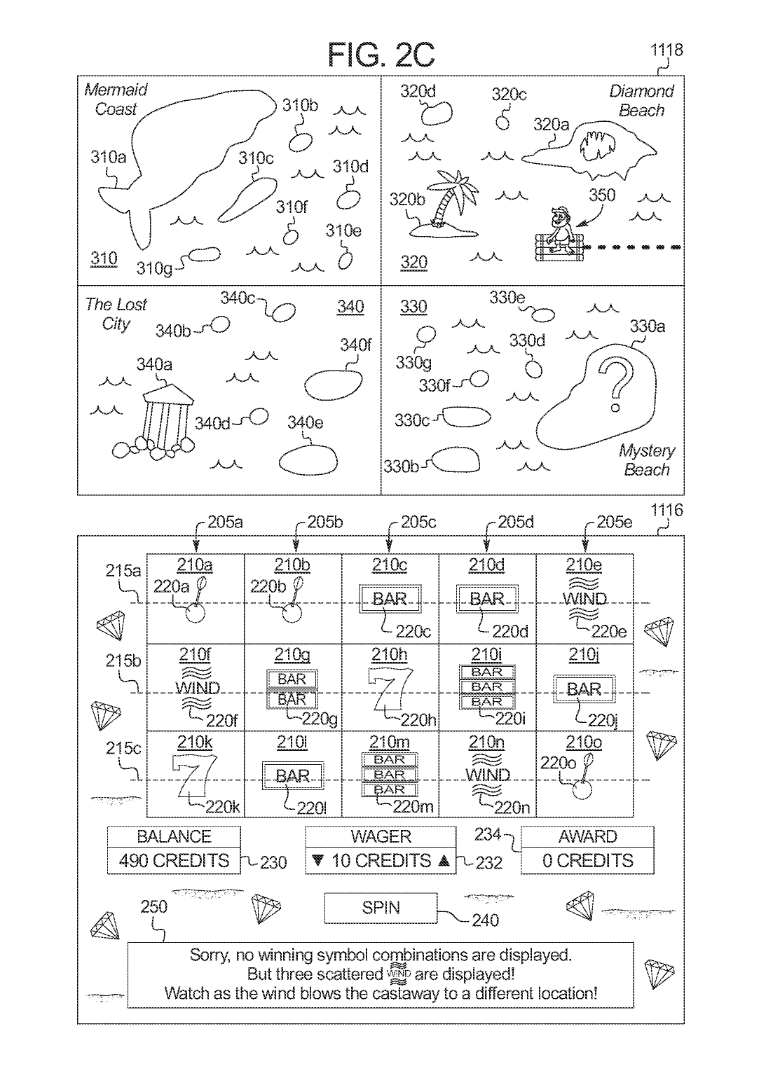

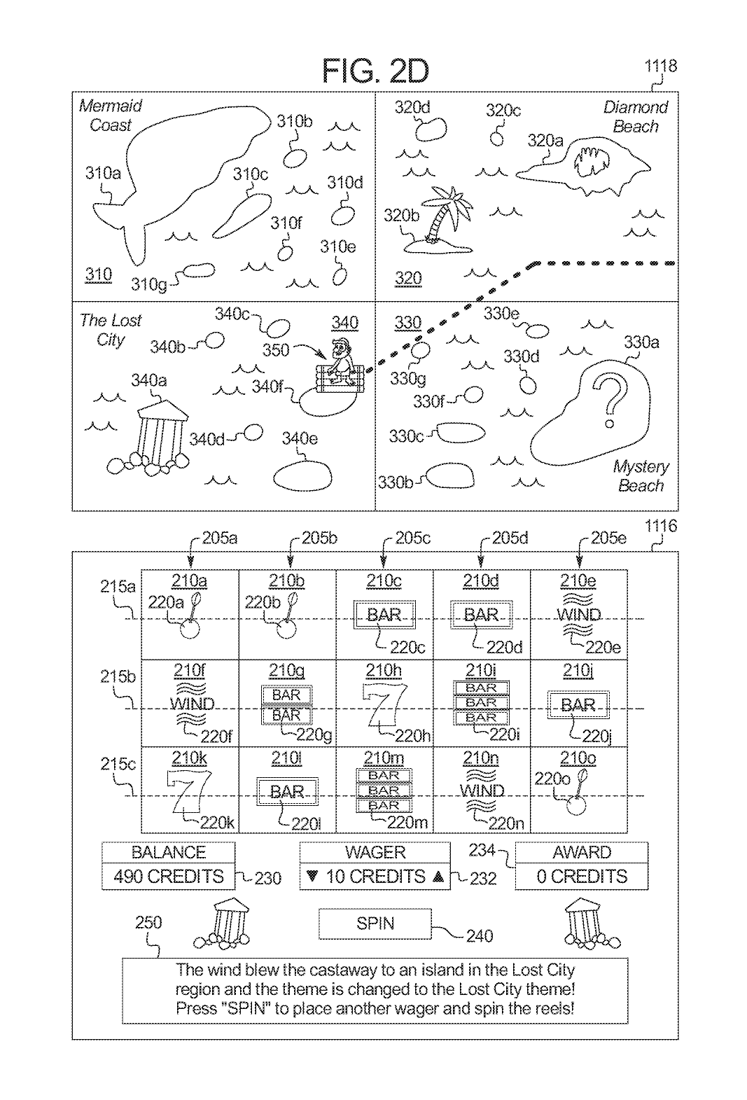

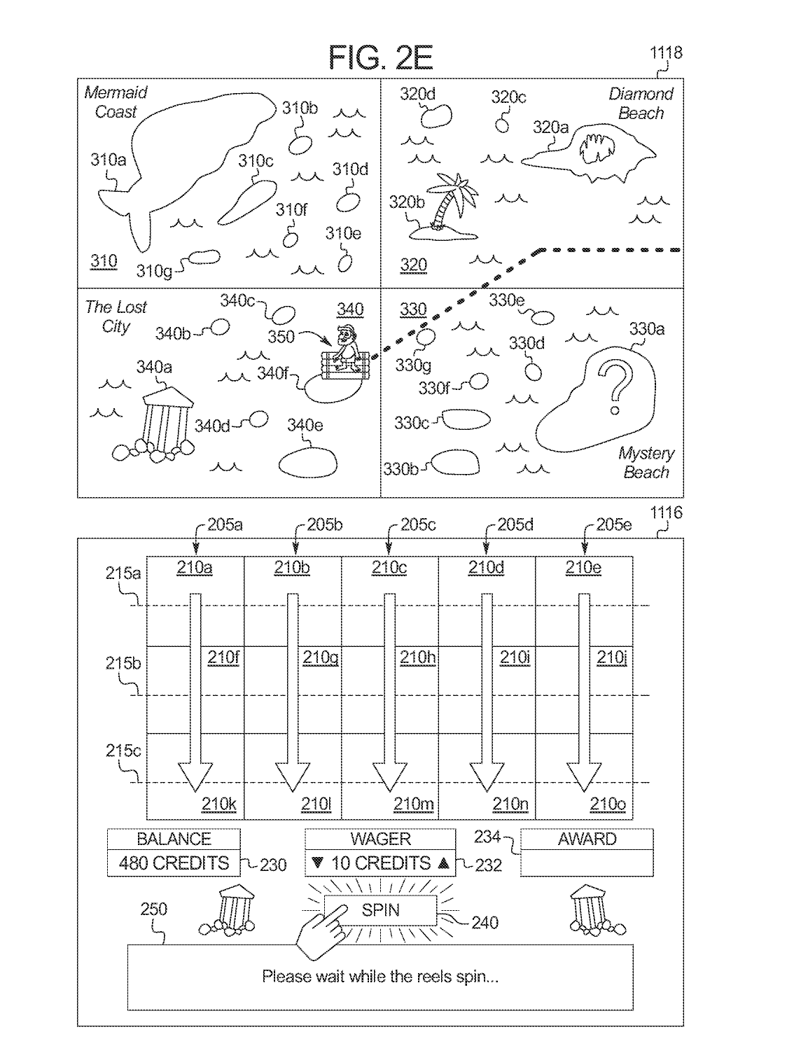

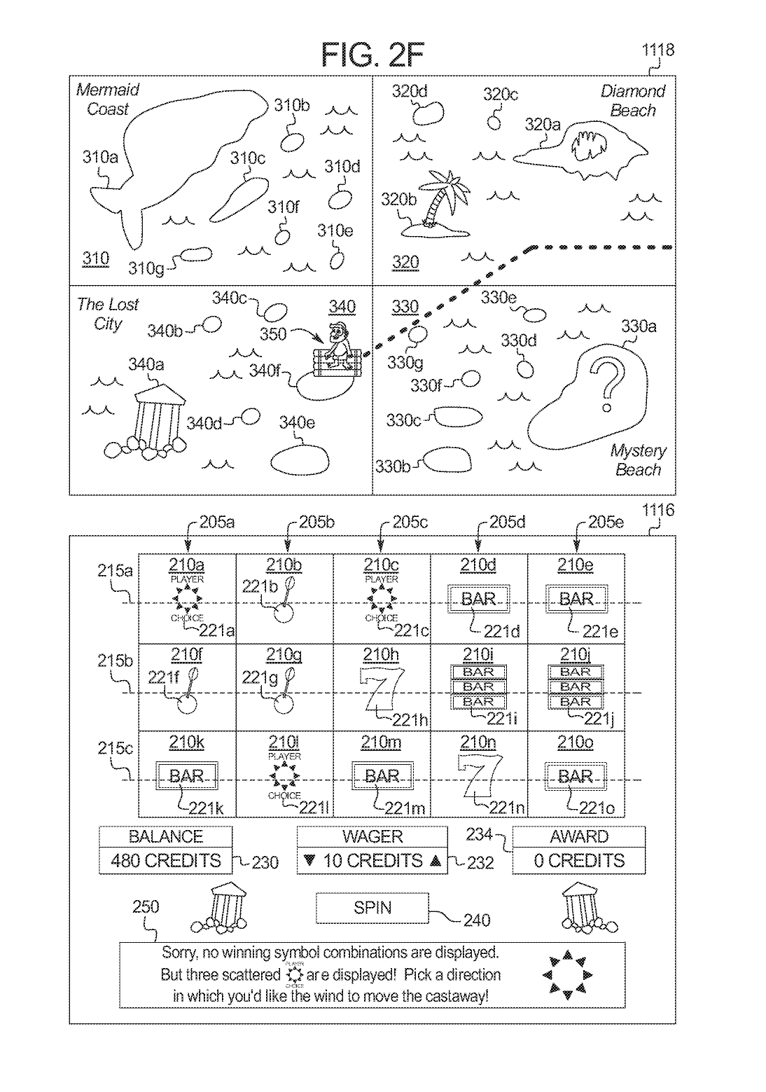

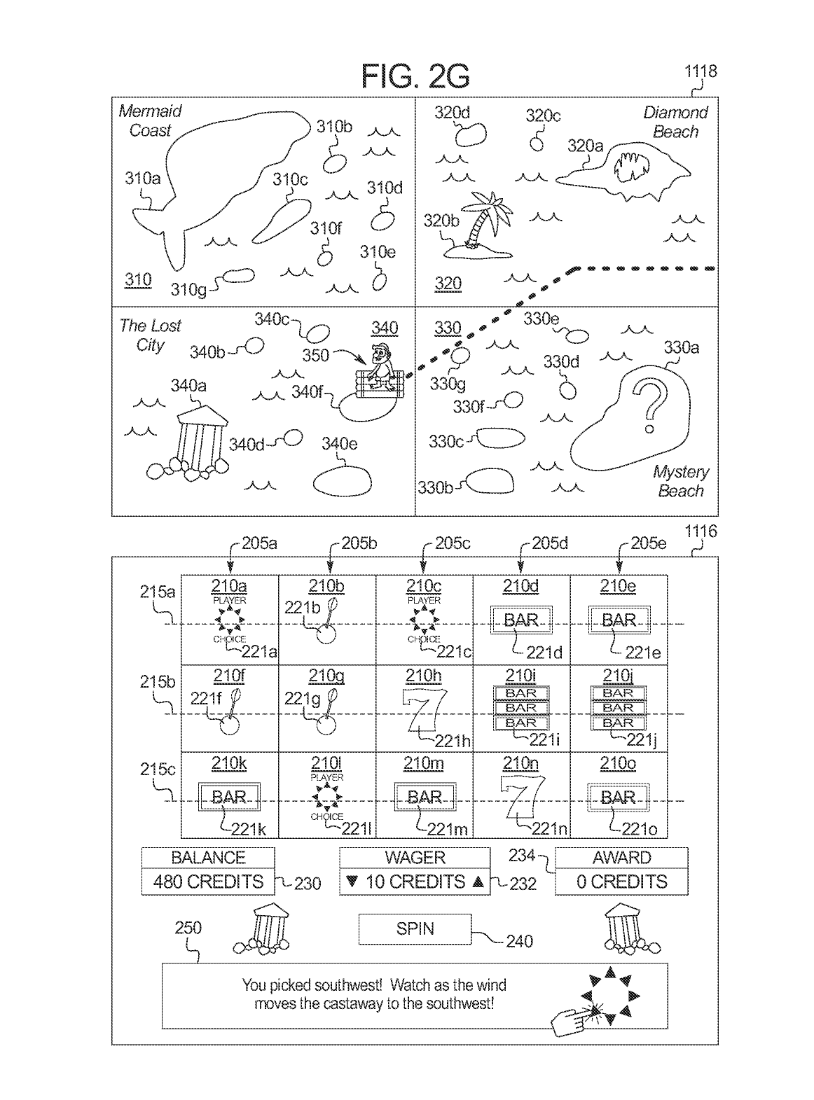

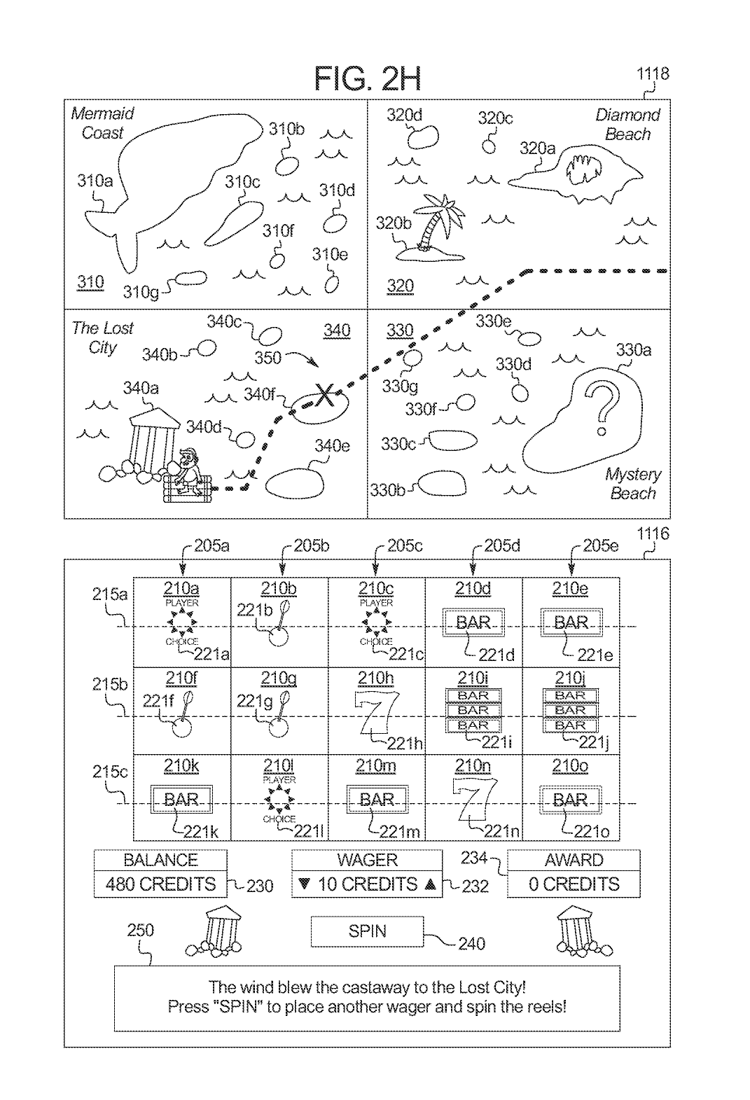

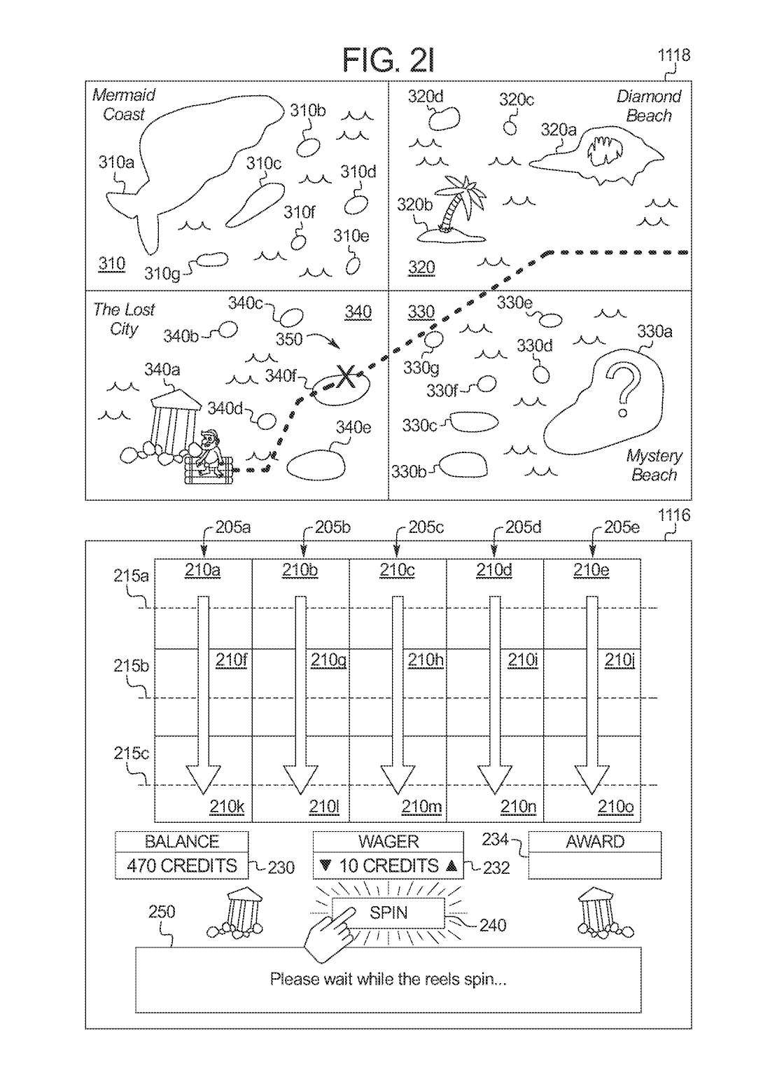

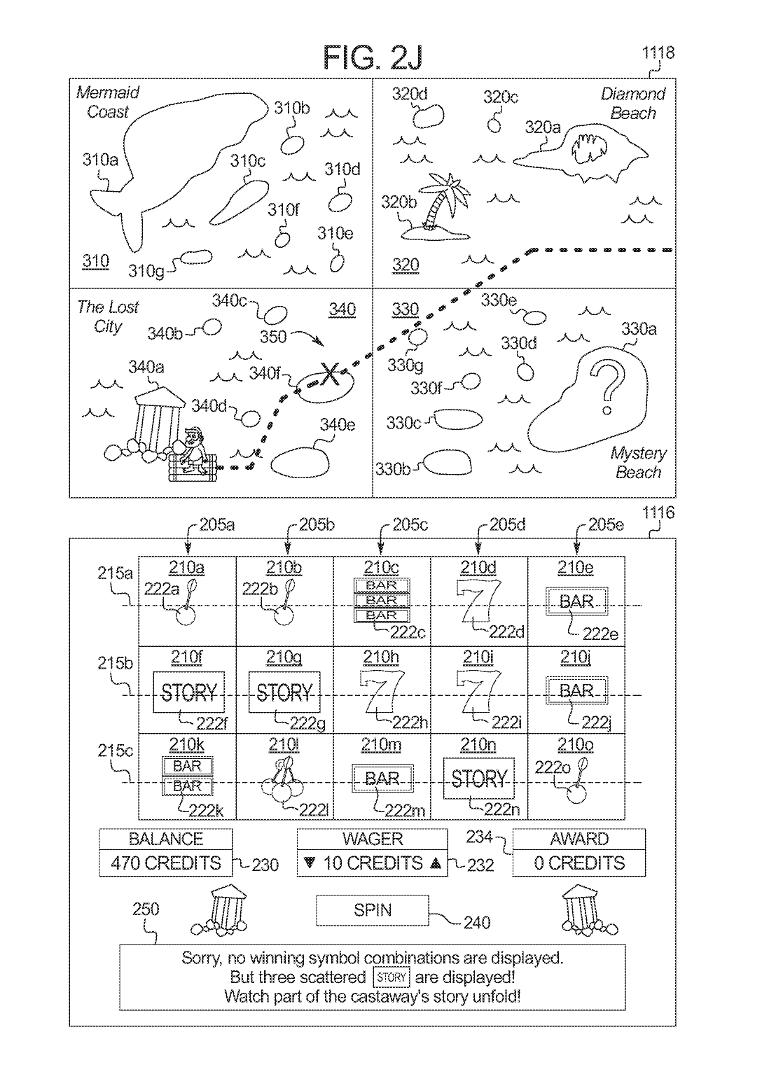

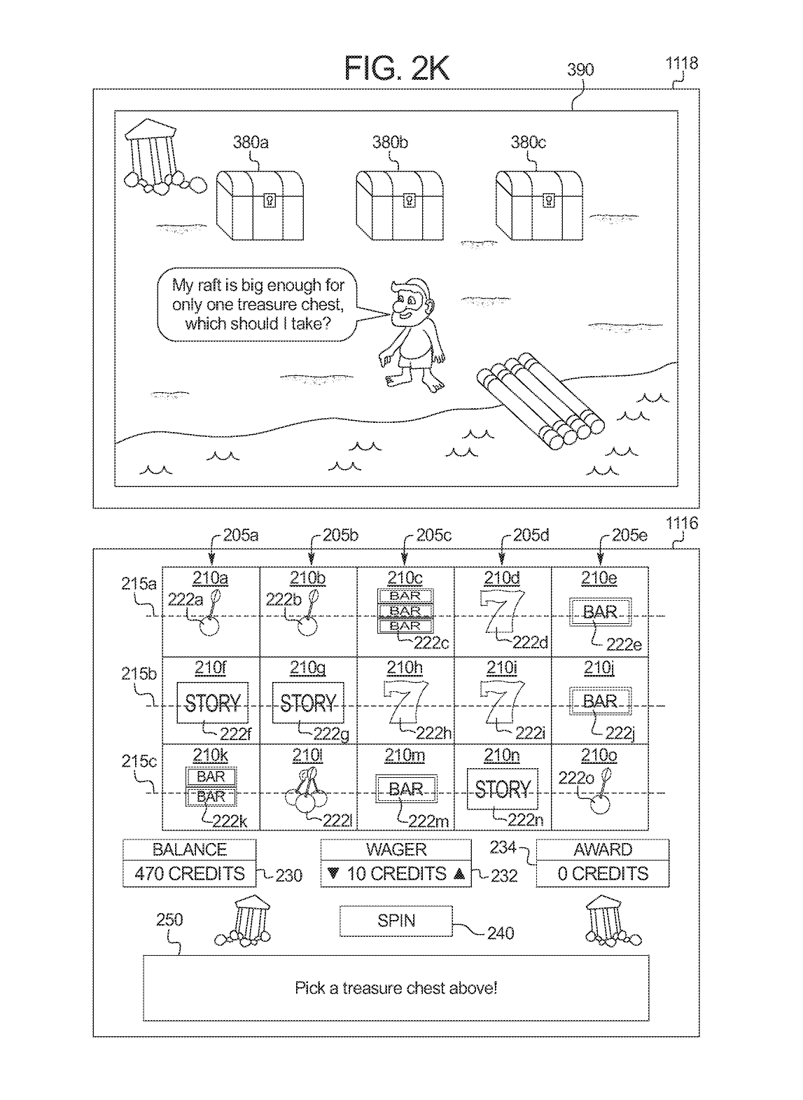

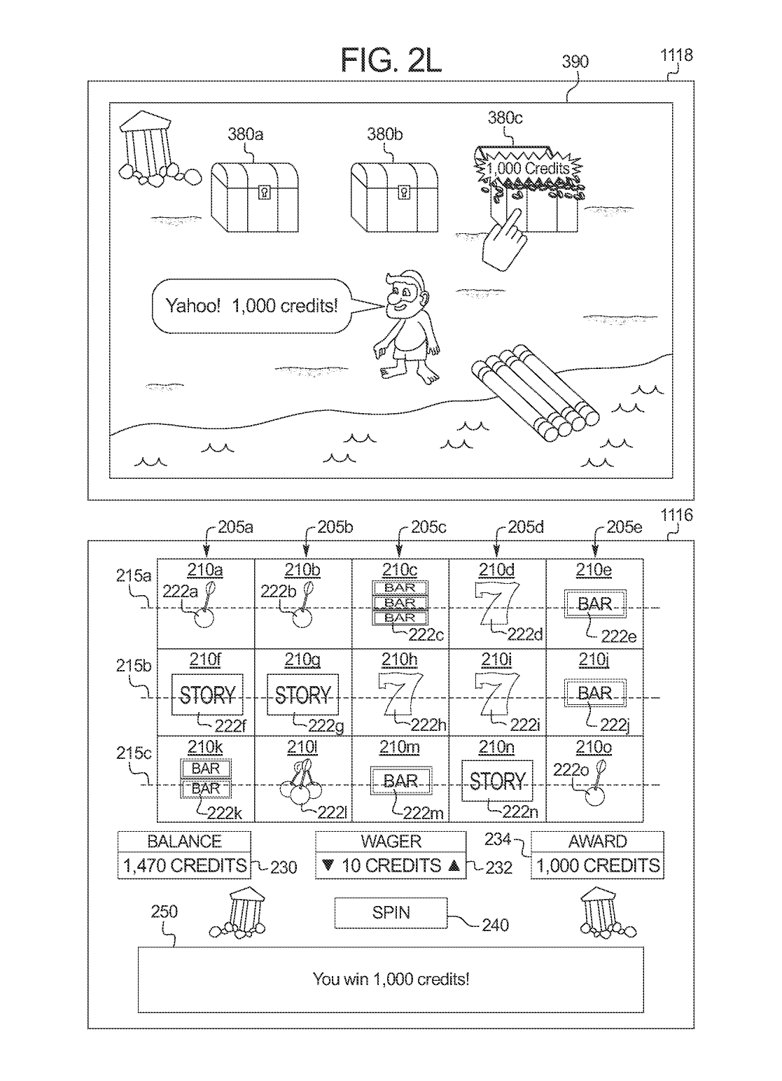

FIGS. 2A, 2B, 2C, 20, 2E, 2F, 2G, 2H, 2I, 2J, 2K, and 2L illustrate screen shots of one example embodiment of the gaming system of the present disclosure operating a primary slot game and a secondary game. In this example embodiment, the gaming system enables the player to: (a) wager on and play the primary slot game, and (b) play the secondary game in association with any wagered-on plays of the primary slot game. Generally, in this example embodiment, certain events that occur during play of the primary slot game trigger the occurrence of certain events in the secondary game. Additionally, in this example embodiment, various events that occur during the secondary game cause the gaming system to change or modify one or more aspects of the primary slot game.

Turning to the secondary game, the gaming system displays, such as on a secondary display device 1118 (described below), a plurality of secondary game regions including a MERMAID COAST REGION 310, a DIAMOND BEACH REGION 320, a MYSTERY BEACH REGION 330, and a LOST CITY REGION 340. For each secondary game region of the secondary game, one or more object visitation areas are associated with that secondary game region. In this example embodiment, the gaming system displays the one or more object visitation areas associated with each secondary game region within or otherwise in association with that secondary game region. More specifically, the gaming system displays: (a) object visitation areas 310a, 310b, 310c, 310d, 310e, 310f, and 310g, which are associated with the MERMAID COAST REGION 310, within the MERMAID COAST REGION 310; (b) object visitation areas 320a, 320b, 320c, and 320d, which are associated with the DIAMOND BEACH REGION 320, within the DIAMOND BEACH REGION 320; (c) object visitation areas 330a, 330b, 330c, 330d, 330e, 330f, and 330g, which are associated with the MYSTERY BEACH REGION 330, within the MYSTERY BEACH REGION 330; and (d) object visitation areas 340a, 340b, 340c, 340d, 340e, and 340f, which are associated with the LOST CITY REGION 340, within the LOST CITY REGION 340.

Each of the secondary game regions is associated with a different one of four different primary themes: (a) the MERMAID COAST REGION 310 is associated with a mermaid coast primary theme, (b) the DIAMOND BEACH REGION 320 is associated with a diamond beach primary theme, (c) the MYSTERY BEACH REGION 330 is associated with a mystery beach primary theme, and (d) the LOST CITY REGION 340 is associated with a lost city primary theme. Further, for each secondary game region, the object visitation areas associated with that secondary game region are also associated with the primary theme with which that secondary game region is associated. More specifically, in this example embodiment: (a) the object visitation areas 310a, 310b, 310c, 310d, 310e, 310f, and 310g, which are associated with the MERMAID COAST REGION 310, are associated with the mermaid coast primary theme; (b) the object visitation areas 320a, 320b, 320c, and 320d, which are associated with the DIAMOND BEACH REGION 320 are associated with the diamond beach primary theme; (c) the object visitation areas 330a, 330b, 330c, 330d, 330e, 330f, and 330g, which are associated with the MYSTERY BEACH REGION 330, are associated with the mystery beach primary theme; and (d) the object visitation areas 340a, 340b, 340c, 340d, 340e, and 340f, which are associated with the LOST CITY REGION 340, are associated with the lost city primary theme.

The gaming system displays a secondary game object 350. In this example embodiment, the gaming system is configured to display the secondary game object 350 moving about the secondary game regions to various object visitation areas in accordance with secondary game object movement events that may occur in association with the primary slot game, as described below. In this example embodiment, upon initiation of the secondary game, the gaming system displays the secondary game object 350 such that the secondary game object 350 is not (initially) displayed in association with any of the object visitation areas. It should be appreciated that, in other embodiments, the gaming system displays the secondary game object in association with one of the object visitation areas (such as a randomly determined or predetermined object visitation area) upon initiation of the secondary game.

Each object visitation area of the secondary game has one of: (a) an unvisited status, and (b) a visited status. In this example embodiment, whether a particular object visitation area has the unvisited status or the visited status is based on whether the gaming system has displayed the secondary game object 350 in association with that particular object visitation area during the secondary game (i.e., in this example embodiment, whether the secondary game object 350 has “visited” that particular object visitation area during the secondary game). More specifically, in this example embodiment, for each object visitation area: (a) that object visitation area has the unvisited status if the gaming system has not displayed the secondary game object 350 in association with that object visitation area during the secondary game (i.e., the secondary game object 350 has not “visited” that object visitation area during the secondary game); and (b) that object visitation area has the visited status if the gaming system has displayed the secondary game object 350 in association with that object visitation area during the secondary game (i.e., the secondary game object 350 has “visited” that object visitation area during the secondary game). In this example embodiment, each object visitation area has the unvisited status upon initiation of the secondary game.

Turning to the primary slot game, the gaming system displays, such as on a primary display device 1116 (described below), a plurality of symbol display areas 210a, 210b, 210c, 210d, 210e, 210f, 210g, 210h, 210i, 210j, 210k, 210l, 210m, 210n, and 210o arranged in a 3×5 grid or matrix. The gaming system also displays a plurality of reels 205a, 205b, 205c, 205d, and 205e, each of which is associated with a plurality of a plurality of symbols the gaming system employs for the primary slot game. Each of the reels 205a, 205b, 205c, 205d, and 205e is associated with, and configured to display symbols at, a plurality of the symbol display areas. More specifically: (a) the reel 205a is associated with, and configured to display symbols at, the symbol display areas 210a, 210f, and 210k; (b) the reel 205b is associated with, and configured to display symbols at, the symbol display areas 210b, 210g, and 210l; (c) the reel 205c is associated with, and configured to display symbols at, the symbol display areas 210c, 210h, and 210m; (d) the reel 205d is associated with, and configured to display symbols at, the symbol display areas 210d, 210i, and 210n; and (e) the reel 205e is associated with, and configured to display symbols at, the symbol display areas 210e, 210j, and 210o.

The gaming system displays a plurality of paylines 215a, 215b, and 215c, each of which is associated with a different plurality of the symbol display areas. More specifically: (a) the payline 215a is associated with the symbol display areas 210a, 210b, 210c, 210d, and 210e; (b) the payline 215b is associated with the symbol display areas 210f, 210g, 210h, 210i, and 210j; and (c) the payline 215c is associated with the symbol display areas 210k, 210l, 210m, 210n, and 210o.

The gaming system also displays: (a) a plurality of meters including: (i) a credit meter 230 that displays the player's credit balance (in credit or currency form), (ii) a wager or bet meter 232 that displays any wager or bet placed on a play of the primary slot game (in credit or currency form), and (iii) an award meter 234 that displays any awards won for the play of the primary slot game (in credit or currency form); (b) a SPIN button 240 that, when actuated by the player, causes the gaming system to initiate a play of the primary slot game; and (c) a message box 250 that displays a variety of messages or indications before, during, or after play of the primary slot game.

In this example embodiment, the primary slot game has or is otherwise associated with a current primary theme that is one of the four primary themes listed above: (a) the mermaid coast primary theme, (b) the diamond beach primary theme, (c) the mystery beach primary theme, or (d) the lost city primary theme. The gaming system determines the current primary theme of the primary slot game based on the region within which the secondary game object 350 is displayed. Put differently, in this example embodiment, the location of the secondary game object 350 controls or determines which of the primary themes the gaining system employs as the current primary theme of the primary slot game. In this example embodiment, the current primary theme of the primary slot game manifests itself as the background of the primary slot game; that is, the gaming system displays a background for the primary slot game that is associated with the current primary theme of the primary slot game. It should be appreciated that, in other embodiments, the current primary theme of the primary game is not associated with or controlled by the secondary game.

Turning to FIG. 2A, the gaming system receives a deposit of value from a player and credits the player with 500 credits (as shown in the credit meter 230). At this point, the secondary game object 350 is located within the DIAMOND BEACH REGION 320, which is associated with the diamond beach primary theme. Thus, at this point, the current primary theme of the primary slot game is the diamond beach primary theme (i.e., the primary theme that is associated with the DIAMOND BEACH REGION 320 within which the secondary game object 350 is displayed), and the gaming system displays a background for the primary slot game that is associated with the current diamond beach primary theme. The gaming system displays the following message in the message box 250: “PRESS ‘SPIN’ TO PLACE A WAGER ON A PLAY OF THE SLOT GAME AND SPIN THE REELS.”

As shown in FIG. 2B, the gaming system receives a wager of 10 credits from the player (as shown in the wager meter 232) and an actuation of the SPIN button 240. Upon receiving the actuation of the SPIN button 240, the gaming system reduces the player's credit balance by the 10 credit wager (as shown in the credit meter 230); initiates a play of the primary slot game; and spins the reels 205a, 205b, 205c, 205d, and 205e. The gaming system displays the following message in the message box 250: “PLEASE WAIT WHILE THE REELS SPIN . . . ”

As illustrated in FIG. 2C, the gaming system stops the reels 205a, 205b, 205c, 205d, and 205e such that: (a) Cherry symbol 220a is displayed at the symbol display area 210a, (b) Cherry symbol 220b is displayed at the symbol display area 210b, (c) Bar symbol 220c is displayed at the symbol display area 210c, (d) Bar symbol 220d is displayed at the symbol display area 210d, (e) Wind symbol 220e is displayed at the symbol display area 210e, (f) Wind symbol 220f is displayed at the symbol display area 210f, (g) Double Bar symbol 220g is displayed at the symbol display area 210g, (h) Seven symbol 220h is displayed at the symbol display area 210h, (i) Triple Bar symbol 220i is displayed at the symbol display area 210i, (j) Bar symbol 220j is displayed at the symbol display area 210j, (k) Seven symbol 220k is displayed at the symbol display area 210k, (l) Bar symbol 220l is displayed at the symbol display area 210l, (m) Triple Bar symbol 220m is displayed at the symbol display area 210m, (n) Wind symbol 220n is displayed at the symbol display area 210n, and (o) Cherry symbol 220o is displayed at the symbol display area 210o.

The gaming system determines any awards associated with the symbols displayed at the symbol display areas by determining whether any winning combinations of the symbols included in a paytable (not shown) associated with the slot game are displayed along any of the wagered-on paylines 215a, 215b, and/or 215c. In this example embodiment, the gaming system determines that no winning symbol combinations are displayed along any of the wagered-on paylines.

The gaming system also determines whether: (a) a first secondary game object movement event occurred, (b) a second secondary game object movement event occurred, and/or (c) a secondary game story event occurred in association with the play of the primary slot game. In this example embodiment: (a) the first secondary game object movement event occurs when three symbol display areas each display a Wind symbol (or any other suitable symbol) (i.e., when three Wind symbols are displayed in a scatter configuration); (b) the second secondary game object movement event occurs when three symbol display areas each display a Player Choice symbol (or any other suitable symbol) (i.e., when three Player Choice symbols are displayed in a scatter configuration); and (c) the secondary game story event occurs when three symbol display areas each display a Story symbol (or any other suitable symbol) (La, when three Story symbols are displayed in a scatter configuration). Here, the gaming system determines that: (a) the first secondary game object movement event occurred because a Wind symbol was displayed at each of three symbol display areas, (b) the second secondary game object movement event did not occur, and (c) the secondary game story event did not occur. The gaming system displays the following message in the message box 250: “SORRY, NO WINNING SYMBOL COMBINATIONS ARE DISPLAYED. BUT THREE SCATTERED WIND SYMBOLS ARE DISPLAYED! WATCH AS THE WIND BLOWS THE CASTAWAY TO A DIFFERENT LOCATION!”

It should be appreciated that the first secondary game object movement event, the second secondary game object movement event, and the secondary game story event may be any other suitable triggering events that occur based on any other suitable factor(s).

In this example embodiment, upon an occurrence of the first secondary game object movement event, the gaming system determines one of the object visitation areas for the secondary game object 350 to “visit”. In this example embodiment, the gaming system determines one of the object visitation areas based (at least in part) on: (a) the statuses of the object visitation areas; and (b) the proximity of the object visitation areas to the secondary game object 350 (i.e., how close the object visitation areas are to the secondary game object 350). Here, for a given object visitation area: (a) a probability of the gaming system determining that object visitation area when that object visitation area has the unvisited status is greater than a probability of the gaming system determining that object visitation area when that object visitation area has the visited status; and (b) a probability of the gaming system determining that object visitation area when that object visitation area is a first distance from the secondary game object 350 is greater than a probability of the gaming system determining that object visitation area when that object visitation area is a second greater distance from the secondary game object 350. Thus, upon the occurrence of the first secondary game object movement event, in this example embodiment, the gaming system is more likely to determine an object visitation area that has the unvisited status and is relatively close to the secondary game object 350 than it is to determine an object visitation area that has the visited status and is relatively far from the secondary game object 350.

In this instance, as shown in FIG. 2D, the gaming system determines the object visitation area 340f, displays the secondary game object 350 traveling toward the determined object visitation area 340f, and displays the secondary game object 350 in association with the determined object visitation area 340f. Since the determined object visitation area 340f has the unvisited status, the gaming system changes the status of the determined object visitation area 340f to the visited status (because the secondary game object 350 has now “visited” the determined object visitation area 340f during the secondary game). The gaming system determines whether the current primary theme of the primary slot game is different than the primary theme associated with the determined object visitation area 340f (that the secondary game object 350 is displayed in association with). Here, the gaming system determines that the current diamond beach primary theme of the primary slot game is different than the lost city primary theme associated with the determined object visitation area 340f. Accordingly, the gaming system changes the current primary theme of the primary slot game to the lost city primary theme, and displays a background for the primary slot game that is associated with the current lost city primary theme. The gaming system displays the following message in the message box 250: “THE WIND BLEW THE CASTAWAY TO AN ISLAND IN THE LOST CITY REGION AND THE THEME IS CHANGED TO THE LOST CITY THEME! PRESS ‘SPIN’ TO PLACE ANOTHER WAGER AND SPIN THE REELS!”

As shown in FIG. 2E, the gaming system receives another wager of 10 credits from the player (as shown in the wager meter 232) and an actuation of the SPIN button 240. Upon receiving the actuation of the SPIN button 240, the gaming system reduces the player's credit balance by the 10 credit wager (as shown in the credit meter 230); initiates another play of the primary slot game; and spins the reels 205a, 205b, 205c, 205d, and 205e. The gaming system displays the following message in the message box 250: “PLEASE WAIT WHILE THE REELS SPIN . . . ”

As illustrated in FIG. 2F, the gaming system stops the reels 205a, 205b, 205c, 205d, and 205e such that: (a) Player Choice symbol 221a is displayed at the symbol display area 210a, (b) Cherry symbol 221b is displayed at the symbol display area 210b, (c) Player Choice symbol 221c is displayed at the symbol display area 210c, (d) Bar symbol 221d is displayed at the symbol display area 210d, (e) Bar symbol 221e is displayed at the symbol display area 210e, (f) Cherry symbol 221f is displayed at the symbol display area 210f, (g) Cherry symbol 221g is displayed at the symbol display area 210g, (h) Seven symbol 221h is displayed at the symbol display area 210h, (i) Triple Bar symbol 221i is displayed at the symbol display area 210i, (j) Triple Bar symbol 221j is displayed at the symbol display area 210j, (k) Bar symbol 221k is displayed at the symbol display area 210k, (l) Player Choice symbol 221l is displayed at the symbol display area 210l, (m) Bar symbol 221m is displayed at the symbol display area 210m, (n) Seven symbol 221n is displayed at the symbol display area 210n, and (o) Bar symbol 221o is displayed at the symbol display area 210o.

The gaming system determines any awards associated with the symbols displayed at the symbol display areas by determining whether any winning combinations of the symbols included in the paytable (not shown) associated with the slot game are displayed along any of the wagered-on paylines 215a, 215b, and/or 215c. In this example embodiment, the gaming system determines that no winning symbol combinations are displayed along any of the wagered-on paylines.

The gaming system also determines whether: (a) the first secondary game object movement event occurred, (b) the second secondary game object movement event occurred, and/or (c) the secondary game story event occurred in association with the play of the primary slot game. Here, the gaming system determines that: (a) the first secondary game object movement event did not occur, (b) the second secondary game object movement event occurred because a Player Choice symbol was displayed at each of three symbol display areas, and (c) the secondary game story event did not occur. The gaming system displays the following message in the message box 250: “SORRY, NO WINNING SYMBOL COMBINATIONS ARE DISPLAYED. BUT THREE PLAYER CHOICE SYMBOLS ARE DISPLAYED! PICK A DIRECTION IN WHICH YOU'D LIKE THE WIND TO MOVE THE CASTAWAY!”

In this example embodiment, upon an occurrence of the second secondary game object movement event, the gaming system: (a) enables the player to select one of a plurality of different directions in which the player desires the secondary game object 350 to move; (b) identifies a subset of the object visitation areas in accordance with the selected direction; and (c) determines one of the object visitation areas of the subset based (at least in part) on: (i) the statuses of the object visitation areas, and (ii) the proximity of the object visitation areas to the secondary game object 350 as described above in association with the occurrence of the first secondary game object movement event. Thus, upon the occurrence of the second secondary game object movement event, in this example embodiment, the gaming system is more likely to determine an object visitation area of the subset that has the unvisited status and is relatively close to the secondary game object 350 than it is to determine an object visitation area of the subset that has the visited status and is relatively far from the secondary game object 350.

In this instance, as shown in FIG. 2G, the gaming system receives a selection of the southwest direction from the player, and displays the following message in the message box 250: “YOU PICKED SOUTHWEST! WATCH AS THE WIND MOVES THE CASTAWAY TO THE SOUTHWEST!”

In this example embodiment, the gaming system identifies the subset of the object visitation area upon the occurrence of the second secondary game object movement event by identifying each object visitation area within a designated proximity of the selected direction and including each identified object visitation area in the subset. Here, the gaming system identifies the following subset of the object visitation areas based on the selected southwest direction: the object visitation area 340a, the object visitation area 340d, and the object visitation area 340e. In this instance, as shown in FIG. 2H, the gaming system determines the object visitation area 340e from the subset, displays the secondary game object 350 traveling toward the determined object visitation area 340e, and displays the secondary game object 350 in association with the determined object visitation area 340e. Since the determined object visitation area 340e has the unvisited status, the gaming system changes the status of the determined object visitation area 340e to the visited status (because the secondary game object 350 has now “visited” the determined object visitation area 340e).

The gaming system determines whether the current primary theme of the primary slot game is different than the primary theme associated with the determined object visitation area 340e (that the secondary game object 350 is displayed in association with). Here, the gaming system determines that the current lost city primary theme of the primary slot game is the same as (i.e., is not different than) the lost city primary theme associated with the determined object visitation area 340e. Accordingly, the gaming system maintains the current lost city primary theme of the primary slot game. The gaming system displays the following message in the message box 250: “THE WIND BLEW THE CASTAWAY TO THE LOST CITY! PRESS ‘SPIN’ TO PLACE ANOTHER WAGER AND SPIN THE REELS!”

As shown in FIG. 2I, the gaming system receives another wager of 10 credits from the player (as shown in the wager meter 232) and an actuation of the SPIN button 240. Upon receiving the actuation of the SPIN button 240, the gaming system reduces the player's credit balance by the 10 credit wager (as shown in the credit meter 230); initiates another play of the primary slot game; and spins the reels 205a, 205b, 205c, 205d, and 205e. The gaming system displays the following message in the message box 250: “PLEASE WAIT WHILE THE REELS SPIN . . . ”

As illustrated in FIG. 2J, the gaming system stops the reels 205a, 205b, 205c, 205d, and 205e such that: (a) Cherry symbol 222a is displayed at the symbol display area 210a, (b) Cherry symbol 222b is displayed at the symbol display area 210b, (c) Triple Bar symbol 222c is displayed at the symbol display area 210c, (d) Seven symbol 222d is displayed at the symbol display area 210d, (e) Bar symbol 222e is displayed at the symbol display area 210e, (f) Story symbol 222f is displayed at the symbol display area 210f, (g) Story symbol 222g is displayed at the symbol display area 210g, (h) Seven symbol 222h is displayed at the symbol display area 210h, (i) Seven symbol 222i is displayed at the symbol display area 210i, (j) Bar symbol 222j is displayed at the symbol display area 210j, (k) Double Bar symbol 222k is displayed at the symbol display area 210k, (l) Triple Cherry symbol 222l is displayed at the symbol display area 210l, (m) Bar symbol 222m is displayed at the symbol display area 210m, (n) Story symbol 222n is displayed at the symbol display area 210n, and (o) Cherry symbol 222o is displayed at the symbol display area 210o.

The gaming system determines any awards associated with the symbols displayed at the symbol display areas by determining whether any winning combinations of the symbols included in the paytable (not shown) associated with the slot game are displayed along any of the wagered-on paylines 215a, 215b, and/or 215c. In this example embodiment, the gaming system determines that no winning symbol combinations are displayed along any of the wagered-on paylines.

The gaming system also determines whether: (a) the first secondary game object movement event occurred, (b) the second secondary game object movement event occurred, and/or (c) the secondary game story event occurred in association with the play of the primary slot game. Here, the gaming system determines that: (a) the first secondary game object movement event did not occur, (b) the second secondary game object movement event did not occur, and (c) the secondary game story event occurred because a Story symbol was displayed at each of three symbol display areas. The gaming system displays the following message in the message box 250: “SORRY, NO WINNING SYMBOL COMBINATIONS ARE DISPLAYED. BUT THREE SCATTERED STORY SYMBOLS ARE DISPLAYED! WATCH PART OF THE CASTAWAY'S STORY UNFOLD!”

In this example embodiment, upon an occurrence of the secondary game story event, the gaming system determines and displays a video segment, such as a live action video segment or an animated video segment, that begins a narrative or storyline associated with the secondary game, continues a narrative or storyline associated with the secondary game, or concludes a narrative or storyline associated with the secondary game. In this example embodiment, the gaming system stores or otherwise is configured to access a plurality of different video segments from which the gaming system determines a video segment upon the occurrence of the secondary game story event. It should be appreciated that the order in which the gaming system determines and displays the video segments upon sequential occurrences of the secondary game story event determines the particular narrative or storyline associated with the secondary game. That is, displaying a particular set of video segments in different orders results in different narratives or storylines.

In this example embodiment, upon an occurrence of the secondary game story event, the gaming system determines one of the video segments based at least in part on: (a) the object visitation area that the secondary game object is displayed in association with; (b) at least one of any video segments previously displayed in association with the secondary game; and (c) the current narrative or storyline, if any, associated with the secondary game. Thus, in this example embodiment, the gaming system does not, without considering additional factors: (a) randomly determine one of the video segments upon the occurrence of the secondary game story event, or (b) determine a video segment according to a predetermined order.

Instead, in this example embodiment, the gaming system tailors the determined and displayed video segments (and, therefore the current narrative or storyline of the secondary game) to correspond to the player's progress in the secondary game by considering one or more factors associated with the secondary game. In other words, once the gaming system begins a narrative or storyline by determining and displaying one of the video segments, the gaming system determines additional video segments upon the occurrences of subsequent secondary game story events to continue that narrative or storyline based on the previous video segment(s) displayed for that narrative or storyline and the location(s) at which the secondary game object is displayed at those particular points in time. The gaming system thus customizes the determined video segments based on the player's game play and progress in the secondary game.

In this example embodiment, certain of the video segments are each associated with an award. Here, when the secondary game story event occurs and the gaming system determines one of the video segments associated with an award, the gaming system displays the determined video segment and provides the award associated with the determined video segment. Additionally, in this example embodiment, certain of the video segments are each associated with a player interactivity element. Here, when the secondary game story event occurs and the gaming system determines one of the video segments associated with a player interactivity element, the gaming system displays the determined video segment and enables certain player interactivity in association with the secondary game.

In this instance, as shown in FIG. 2K, since no video segments have been previously displayed in association with the secondary game and there is no current narrative or storyline associated with the secondary game, the gaming system determines one of the video segments based on the object visitation area 340a, which is the object visitation area that the secondary game object 350 is displayed in association with. The gaming system displays the determined video segment in a pop-up window 390. In this example embodiment, the determined video segment is associated with a player interactivity element in the form of a pick bonus game. Here, the gaming system enables the player to pick one of three selections 380a, 380b, and 380c. The gaming system displays the following message in the message box 250: “PICK A TREASURE CHEST ABOVE!” As shown in FIG. 2L, the gaming system receives a pick of the selection 380c from the player, and provides the player a 1,000 credit award associated with the picked selection 380c. The gaming system displays the following message in the message box 250: “YOU WIN 1,000 CREDITS!”

### Variations

In certain embodiments, upon an occurrence of the first secondary game object movement event, the gaming system determines one of the object visitation areas by: (a) identifying a subset of the object visitation areas; and (b) determining one of the object visitation areas of the subset based (at least in part) on the statuses of the object visitation areas of the subset. In these embodiments, for a given object visitation area, a probability of the gaming system determining that object visitation area when that object visitation area has the unvisited status is greater than a probability of the gaming system determining that object visitation area when that object visitation area has the visited status. Thus, in these embodiments, the gaming system is more likely to determine an object visitation area of the subset that has the unvisited status than it is to determine an object visitation area of the subset that has the visited status.

It should be appreciated that, in these embodiments, the gaming system determines which object visitation areas to include in the subset in any suitable manner. For instance, in one example embodiment, the gaming system includes the object visitation areas adjacent to the secondary game object in the subset. In another example embodiment, the gaming system includes the object visitation areas within a designated distance from the secondary game object in the subset.

In various embodiments, the gaming system displays an indicator that represents the direction in which the secondary game object will move if the first secondary game object movement event occurs. For instance, in one example embodiment, the gaming system displays a weather vane that points to the direction in which the secondary game object will move if the first secondary game object movement occurs. It should be appreciated that the gaming system may change the direction to which the indicator is pointing (e.g., by shifting or spinning the indicator) at any suitable point and in any suitable manner. For instance, in one example embodiment, for each play of the primary slot game, the gaming system randomly determines the direction to which the indicator will point and shifts or spins the indicator (if necessary) such that the indicator points to that randomly determined direction for that play of the primary slot game.

In certain embodiments, upon an occurrence of the first secondary game object movement event, the gaming system determines one of the object visitation areas based on the statuses of one or more of the object visitation areas and not based on the proximity of those one or more of the object visitation areas to the secondary game object. In other embodiments, upon an occurrence of the second secondary game object movement event, the gaming system determines one of the object visitation areas based on the player-selected direction and the statuses of one or more of the object visitation areas and not based on the proximity of those one or more of the object visitation areas to the secondary game object.

In other embodiments, upon an occurrence of the second secondary game object movement event, the gaming system enables the player to select any one of the object visitation areas that the player desires the secondary game object to visit, and subsequently: (a) displays the secondary game object traveling toward the player-selected object visitation area, and (b) displays the secondary game object in association with the player-selected object visitation area. In further embodiments, the gaming system enables the player to select any one of a subset of one or more of the object visitation areas that the player desires the secondary game object to visit, and subsequently: (a) displays the secondary game object traveling toward the player-selected object visitation area, and (b) displays the secondary game object in association with the player-selected object visitation area.

In certain embodiments, each of the object visitation areas is associated with one of a plurality of different secondary themes. In these embodiments, the secondary game has or is otherwise associated with a current secondary theme that is one of the secondary themes. Here, the gaming system determines the current secondary theme of the secondary game based on the secondary theme of the object visitation area that the secondary game object is displayed in association with. Put differently, in this example embodiment, the location of the secondary game object controls or determines which of the secondary themes the gaming system employs as the current secondary theme of the secondary game.

It should be appreciated that the current secondary theme of the secondary game may manifest itself in one or more of a plurality of different manners, such as (but not limited to): (a) the background of the secondary game is associated with the current secondary theme; (b) one or more sound effects of the secondary game are associated with the current secondary theme; (c) one or more bonus games that may be triggered in association with the secondary game are associated with the current secondary theme; (d) one or more video segments displayed in association with the secondary game are associated with the current secondary theme; (e) one or more still images displayed in association with the secondary game are associated with the current secondary theme; (f) one or more awards that a player may win in association with the secondary game are associated with the current secondary theme; and/or (g) one or more advertisements or promotions displayed in association with the secondary game are associated with the current secondary theme.

In certain embodiments, the primary and secondary themes are the same.

In various embodiments, one of the regions (and/or areas) of the secondary game is an initially-locked region (and/or area). In these embodiments, the gaming system does not enable the secondary game object to move into the locked region (and/or the locked area) until an unlock event occurs. For instance, in one example embodiment, the gaming system enables the player to collect keys during play of the primary game and/or the secondary game, and the unlock event occurs when the player has collected a designated quantity of keys or a set of particular keys (such as one key of each of three different colors). In another example embodiment, the unlock event occurs when a designated quantity of the object visitation areas have the visited status. In another example embodiment, the unlock event occurs when a set of one or more particular object visitation areas have the visited status.

It should be appreciated that the gaming system may move the secondary game object in instances other than upon the occurrence of the first secondary game object movement event or the second secondary game object movement event, such as (but not limited to) when: (a) the gaming system provides a designated award; (b) a total quantity of plays of the primary game played by the player reaches a designated quantity of plays; (c) the gaming system receives a deposit of currency or credits to fund the gaming system at least a designated quantity of times from the player; (d) a total amount wagered by the player on the primary game reaches a designated amount wagered; (e) a total amount of credits or currency won by the player reaches a designated amount won; (f) a total amount of credits or currency lost by the player reaches a designated amount lost; (g) a time of day reaches a designated time of day; (h) a length of a gaming session of the player reaches a designated length of time; (i) a play of a bonus game has not been provided within a designated amount of time during the gaming session; (j) a play of a secondary or bonus game has not been provided within a designated quantity of plays of the primary game during the gaming session; (k) the player achieves a designated quantity of consecutive winning outcomes; (l) one or more designated events occur; (m) the player achieves a designated quantity of consecutive losing outcomes; (n) a total quantity of winning outcomes achieved by the player reaches a designated quantity; (o) a total quantity of losing outcomes achieved by the player reaches a designated quantity; (p) a total quantity of coin-in during the gaming session reaches a designated quantity; (q) a credit balance of the player reaches a designated credit balance; (r) a total amount of currency deposited by the player during the gaming session reaches a designated amount; (s) a change in frequency of play reaches a designated amount; (t) a ticket, coupon, or promotion is inserted or otherwise entered (such as by typing in a promotion code or scanning a barcode); (u) a designated quantity of credits is transferred onto the gaming system; (v) one or more player tracking points are redeemed; (w) merchandise is purchased on the gaming system (such as through the use of player tracking points); (x) a contribution is made to charity through the use of the gaming system; (y) an update is posted onto a social networking website; (z) a status is changed on a social networking website; (aa) a gaming establishment (such as a casino) is liked or shared via a social networking website; (bb) a picture is submitted; (cc) an email address is supplied; and (dd) a survey is completed.

In certain embodiments, the gaming system may provide the player a play of a bonus game when the secondary game object “visits” one of the object visitation areas. For instance, in one example embodiment, the gaming system randomly determines whether to provide a play of a bonus game whenever one of the secondary game object movement events occurs to cause the secondary game object to “visit” one of the object visitation area. In another example embodiment, certain object visitation areas are associated with a bonus game (which the gaming system may or may not indicate to the player). In this example embodiment, when the secondary game object “visits” an object visitation area that is associated with the bonus game, the gaming system provides a play of the bonus game. In another example embodiment, when the secondary game object “visits” an object visitation area that is associated with the bonus game, the gaming system randomly determines whether to provide a play of the bonus game. In another example embodiment, the gaming system does not provide a play of a bonus game when the secondary game object “visits” an object visitation area that has the visited status (i.e., that the secondary game object has already “visited” at least once during the secondary game),

It should be appreciated that the player interactivity element associated with a given video segment may be any suitable player interactivity. For instance, in one example embodiment, when the gaming system determines a video segment associated with player interactivity, the gaming system enables the player to determine a direction the narrative or storyline will take.

In certain embodiments, the gaming system may provide multiple narratives or storylines associated with the secondary game at any given time. For instance, in one example embodiment in which the secondary game is associated with a castaway trying to find his way home, the gaming system provides: (a) a plurality of different mini-narratives or mini-storylines that are relatively short and simple and that show various escapades of the castaway, and (b) a longer narrative or storyline that is more complex and associated with the castaway's back story.

In various embodiments, the gaming system modifies one or more aspects of the secondary game as time passes. For instance, in one example embodiment in which the secondary game is associated with a castaway trying to find his way home, the gaming system initially displays the castaway as clean-shaven and, as time progresses (such as after a designated time period elapses or after a designated quantity of game plays have occurred), displays the castaway's beard growing.

In certain embodiments, the plurality of symbols the gaming system employs for the primary slot game includes a plurality of different Story symbols, each of which is associated with or includes an image. In these embodiments, the secondary game story event occurs when a designated quantity (such as three) of the Story symbols are displayed for a play of the primary slot game. Here, upon an occurrence of the secondary game story event, the displayed Story symbols and, more particularly, the images of the displayed Story symbols, represent a story or narrative. For instance, in one example embodiment, the secondary game is associated with a soap opera theme and certain of the Story symbols include character images while other Story symbols include images of a heart. In this example embodiment, when two Story symbols including character images and one Story symbol including a heart image are displayed, the gaming system displays the characters “coming to life” and romancing one another, and provides an award (such as each time the characters kiss). It should thus be appreciated that, in these embodiments, the gaming system begins, continues or concludes the storyline or narrative of the secondary game based on different combinations of designated symbols being displayed during play of the primary slot game.

In various embodiments, upon an occurrence of an object visitation area addition event, the gaming system displays at least one additional object visitation area. In certain such embodiments, upon the occurrence of the object visitation area addition event, the gaming system replaces at least one displayed object visitation area with at least one new or different object visitation area. For instance, in one example embodiment, upon the occurrence of the object visitation area addition event, the gaming system replaces at least one displayed object visitation area having the visited status with at least one new or different object visitation area having the unvisited status. In other such embodiments, upon the occurrence of the object visitation area addition event, the gaming system displays at least one new or different object visitation area. For instance, in one example embodiment, upon the occurrence of the object visitation area addition event, the gaming system displays at least one new or different object visitation area having the unvisited status. It should be appreciated that the object visitation area addition event may be any suitable triggering event, such as a designated symbol combination being displayed for a play of the primary game or a designated quantity of the displayed object visitation areas (such as all of the displayed object visitation areas) having the visited status.

In certain embodiments, upon an occurrence of a rearrangement event, the gaming system rearranges one or more of the displayed object visitation areas such that each rearranged object visitation area is associated with a different region that it was associated with prior to the occurrence of the triggering event. For instance, in one example embodiment, a first object visitation area is associated with a first region and a second different object visitation area is associated with a second different region. In this example embodiment, upon an occurrence of the triggering event, the gaming system rearranges the object visitation areas such that the first object visitation area is associated with the second region and the second object visitation area is associated with the first region. It should be appreciated that the rearrangement event may be any suitable triggering event, such as a designated symbol combination being displayed for a play of the primary game.

In certain embodiments, when the gaming system provides a player with a designated award (such as a top award or a progressive award), the gaming system determines one of the video segments that ends a current narrative or storyline and displays the determined video segment. For instance, in one example embodiment in which the secondary game is associated with a castaway trying to find his way home, when the gaming system displays a Rescue symbol, the gaming system: (a) provides a jackpot award, (b) determines a video segment that ends the current narrative or storyline with the castaway being rescued, and (c) displays the determined video segment.

In various embodiments, the secondary game story event occurs when at least one of the first secondary game object movement event occurs and the second secondary game object movement event occurs. Thus, in these embodiments, the gaming system determines and displays a video segment whenever the gaming system moves the secondary game object to one of the object visitation areas.

While in certain of the embodiments described herein the gaming system determines and displays a video segment upon the occurrence of the secondary game story event, it should be appreciated that the gaming system may provide any suitable media segment upon the occurrence of the secondary game story event. For instance, in various embodiment, upon the occurrence of the secondary game story event, the gaming system: (a) determines and displays a still image; (b) determines and displays a plurality of still images; (c) determines and displays text; (d) determines and outputs one or more sound effects; and/or (e) determines and outputs tactile feedback.

It should be appreciated that the secondary game may be a persistence game. In one embodiment, the secondary game is persistent in association with a particular gaming system, such as an EGM. Thus, in this embodiment, multiple players may sequentially play a single instance of the secondary game. In another embodiment, the secondary game is persistent in association with a particular player. In this embodiment, when a player desires to stop playing and leave an EGM, the gaming system stores an indication of the player's progress in the secondary game and enables the player to resume the secondary game when the player returns to play.

It should also be appreciated that the secondary game may be provided in a multiplayer format. For instance, in one example embodiment, a bank of ten EGMs at a gaming establishment are connected to the secondary display device that displays the secondary game. In this example embodiment, the players of those EGMs play the secondary game in a community fashion.

It should be appreciated that the awards may be any suitable awards such as, but not limited to: (1) monetary credits or currency; (2) non-monetary credits or currency; (3) a modifier (such as a multiplier) used to modify one or more awards; (4) one or more free plays of a game (such as one or more free spins of a slot game); (5) one or more plays of one or more bonus games (such as a free spin of an award wheel); (6) one or more lottery based awards (such as one or more lottery or drawing tickets); (7) a wager match for one or more plays of the a wagering game; (8) an increase in an average expected payback percentage of a bonus game and/or an average expected payback percentage of a primary wagering game for one or more plays; (9) one or more comps (such as a free dinner or a free night's stay at a hotel); (10) one or more bonus or promotional credits usable for online play; (11) one or more player tracking points; (12) a multiplier for player tracking points or credits; (13) an increase in a membership or player tracking level; (14) one or more coupons or promotions usable within a gaming establishment and/or outside of the gaming establishment (e.g., a 20% off coupon for use at a retail store or a promotional code providing a deposit match for use in association with an online casino); (15) an access code usable to unlock content on the Internet; (16) a progressive jackpot or other progressive award; (17) a high value product or service (such as a car); and/or (18) a low value product or service (such as a teddy bear).

In certain embodiments, the gaming system displays the primary game and the secondary game in a split-screen format on a single display device. In other embodiments, the gaming system displays the secondary game in a service window. In further embodiments, the gaming system causes a personal gaming device of the player, such as a laptop computer, a tablet computer, or a mobile telephone, to display the secondary game.

It should be appreciated that:
(1) the quantity of regions associated with the secondary game;
(2) the quantity of object visitation areas associated with the secondary game;
(3) the quantity of object visitation areas associated with each particular region of the secondary game;
(4) which particular object visitation areas are associated with each particular region of the secondary game;
(5) the quantity of primary themes;
(6) the particular primary themes;
(7) which particular primary themes are associated with each particular region of the secondary game;
(8) the location at which the secondary game object is initially displayed upon initiation of the secondary game;
(9) the initial status of each object visitation area (i.e., whether each object visitation area initially has the unvisited status or the visited status);
(10) the quantity of symbol display areas of the primary slot game;
(11) the quantity of reels of the primary slot game;
(12) the particular symbol display areas associated with the different reels;
(13) the quantity of paylines of the primary slot game;
(14) which particular symbol display areas the different paylines are associated with;
(15) the manner in which the current primary theme of the primary game manifests itself;
(16) the paytable employed for the primary game;
(17) the first secondary game object movement event;
(18) the second secondary game object movement event;
(19) the secondary game story event;
(20) how the gaming system determines an object visitation area upon the occurrence of the first secondary game object movement event;
(21) how the gaming system determines an object visitation area upon the occurrence of the second secondary game object movement event;
(22) how the gaming system determines a subset of the object visitation areas upon the occurrence of the first or second secondary game object movement event;
(23) the variables the gaming system employs to determine an object visitation area upon the occurrence of the first secondary game object movement event or the second secondary game object movement event;
(24) the variables the gaming system employs to determine a video segment upon the occurrence of the secondary game story event;
(25) the quantity of video segments;
(26) the type of video segments;
(27) the content of the video segments;
(28) the player interactivity elements associated with the video segment(s); and/or
(29) any other variables or determinations described herein

may be: (1) predetermined; (2) randomly determined; (3) randomly determined based on one or more weighted percentages (such as according to a weighted table); (4) determined based on a generated symbol or symbol combination; (5) determined independent of a generated symbol or symbol combination; (6) determined based on a random determination by a central controller (described below); (7) determined independent of a random determination by the central controller; (8) determined based on a random determination at an EGM configured to operate the slot game (described below); (9) determined independent of a random determination at the EGM; (10) determined based on at least one play of at least one game; (11) determined independent of at least one play of at least one game; (12) determined based on a player's selection; (13) determined independent of a player's selection; (14) determined based on one or more side wagers placed; (15) determined independent of one or more side wagers placed; (16) determined based on the player's primary game wager or wager level; (17) determined independent of the player's primary game wager or wager level; (18) determined based on time (such as the time of day); (19) determined independent of time (such as the time of day); (20) determined based on an amount of coin-in accumulated in one or more pools; (21) determined independent of an amount of coin-in accumulated in one or more pools; (22) determined based on a status of the player (i.e., a player tracking status); (23) determined independent of a status of the player (i.e., a player tracking status); (24) determined based on one or more other determinations disclosed herein; (25) determined independent of any other determination disclosed herein; and/or (26) determined in any other suitable manner or based on or independent of any other suitable factor(s).

### Gaming Systems

It should be appreciated that the above-described embodiments of the present disclosure may be implemented in accordance with or in conjunction with one or more of a variety of different types of gaming systems, such as, but not limited to, those described below.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal gaming devices, such as desktop computers, laptop computers, tablet computers or computing devices, personal digital assistants (PDAs), mobile telephones such as smart phones, and other mobile computing devices.

Thus, in various embodiments, the gaming system of the present disclosure includes: (a) one or more EGMs in combination with one or more central servers, central controllers, or remote hosts; (b) one or more personal gaming devices in combination with one or more central servers, central controllers, or remote hosts; (c) one or more personal gaming devices in combination with one or more EGMs; (d) one or more personal gaming devices, one or more EGMs, and one or more central servers, central controllers, or remote hosts in combination with one another; (e) a single EGM; (f) a plurality of EGMs in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity, each EGM and each personal gaming device of the present disclosure is collectively referred to herein as an “EGM.” Additionally, for brevity and clarity, unless specifically stated otherwise, “EGM” as used herein represents one EGM or a plurality of EGMs, and “central server, central controller, or remote host” as used herein represents one central server, central controller, or remote host or a plurality of central servers, central controllers, or remote hosts.

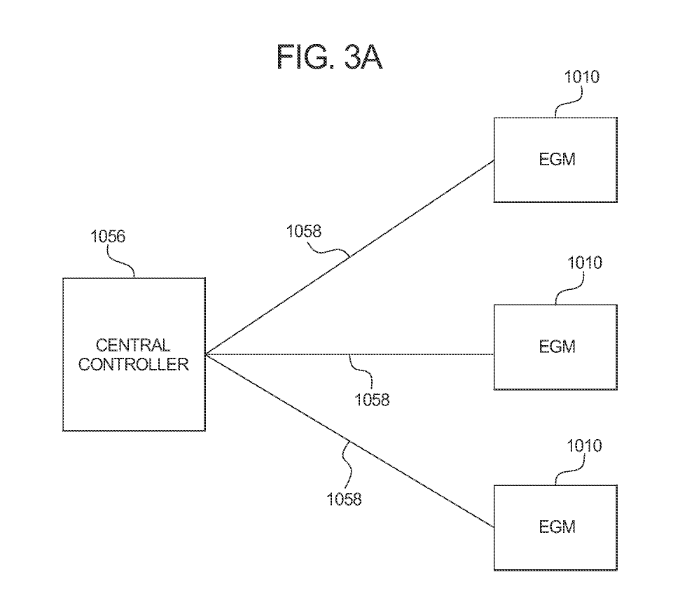

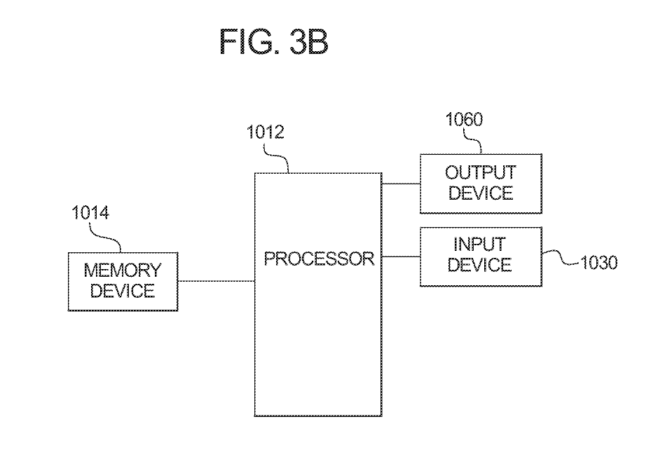

As noted above, in various embodiments, the gaming system includes an EGM in combination with a central server, central controller, or remote host. In such embodiments, the EGM is configured to communicate with the central server, central controller, or remote host through a data network or remote communication link. In certain such embodiments, the EGM is configured to communicate with another EGM through the same data network or remote communication link or through a different data network or remote communication link. For example, the gaming system illustrated in FIG. 3A includes a plurality of EGMs 1010 that are each configured to communicate with a central server, central controller, or remote host 1056 through a data network 1058.

In certain embodiments in which the gaming system includes an EGM in combination with a central server, central controller, or remote host, the central server, central controller, or remote host is any suitable computing device (such as a server) that includes at least one processor and at least one memory device or storage device. As further described below, the EGM includes at least one EGM processor configured to transmit and receive data or signals representing events, messages, commands, or any other suitable information between the EGM and the central server, central controller, or remote host. The at least one processor of that EGM is configured to execute the events, messages, or commands represented by such data or signals in conjunction with the operation of the EGM. Moreover, the at least one processor of the central server, central controller, or remote host is configured to transmit and receive data or signals representing events, messages, commands, or any other suitable information between the central server, central controller, or remote host and the EGM. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the EGM. It should be further appreciated that one, more, or each of the functions of the at least one processor of the EGM may be performed by the at least one processor of the central server, central controller, or remote host.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs are implemented in a thin client environment, and certain other functions of one or more of the EGMs are implemented in a thick client environment. In one such embodiment in which the gaming system includes an EGM and a central server, central controller, or remote host, computerized instructions for controlling any primary or base games displayed by the EGM are communicated from the central server, central controller, or remote host to the EGM in a thick client configuration, and computerized instructions for controlling any secondary or bonus games or other functions displayed by the EGM are executed by the central server, central controller, or remote host in a thin client configuration.

In certain embodiments in which the gaming system includes: (a) an EGM configured to communicate with a central server, central controller, or remote host through a data network; and/or (b) a plurality of EGMs configured to communicate with one another through a data network, the data network is a local area network (LAN) in which the EGMs are located substantially proximate to one another and/or the central server, central controller, or remote host. In one example, the EGMs and the central server, central controller, or remote host are located in a gaming establishment or a portion of a gaming establishment.

In other embodiments in which the gaming system includes: (a) an EGM configured to communicate with a central server, central controller, or remote host through a data network; and/or (b) a plurality of EGMs configured to communicate with one another through a data network, the data network is a wide area network (WAN) in which one or more of the EGMs are not necessarily located substantially proximate to another one of the EGMs and/or the central server, central controller, or remote host. For example, one or more of the EGMs are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs are located. It should be appreciated that in certain embodiments in which the data network is a WAN, the gaming system includes a central server, central controller, or remote host and an EGM each located in a different gaming establishment in a same geographic area, such as a same city or a same state. It should be appreciated that gaming systems in which the data network is a WAN are substantially identical to gaming systems in which the data network is a LAN, though the quantity of EGMs in such gaming systems may vary relative to one another.

In further embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

### EGM Components

In various embodiments, an EGM includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASICs). FIG. 3B illustrates an example EGM including a processor 1012.

As generally noted above, the at least one processor of the EGM is configured to communicate with, configured to access, and configured to exchange signals with at least one memory device or data storage device. In various embodiments, the at least one memory device of the EGM includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). The example EGM illustrated in FIG. 3B includes a memory device 1014. It should be appreciated that any other suitable magnetic, optical, and/or semiconductor memory may operate in conjunction with the EGM disclosed herein. In certain embodiments, the at least one processor of the EGM and the at least one memory device of the EGM both reside within a cabinet of the EGM (as described below). In other embodiments, at least one of the at least one processor of the EGM and the at least one memory device of the EGM reside outside the cabinet of the EGM (as described below).

In certain embodiments, as generally described above, the at least one memory device of the EGM stores program code and instructions executable by the at least one processor of the EGM to control the EGM. The at least one memory device of the EGM also stores other operating data, such as image data, event data, input data, random number generators (RNGs) or pseudo-RNGs, paytable data or information, and/or applicable game rules that relate to the play of one or more games on the EGM (such as primary or base games and/or secondary or bonus games as described below). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an internet or intranet).

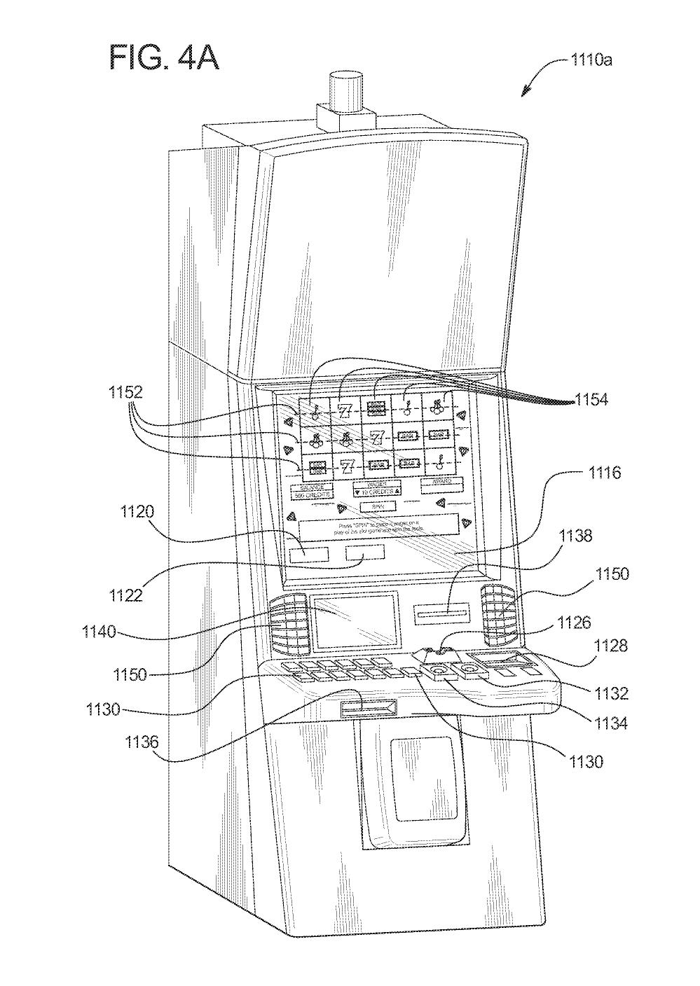

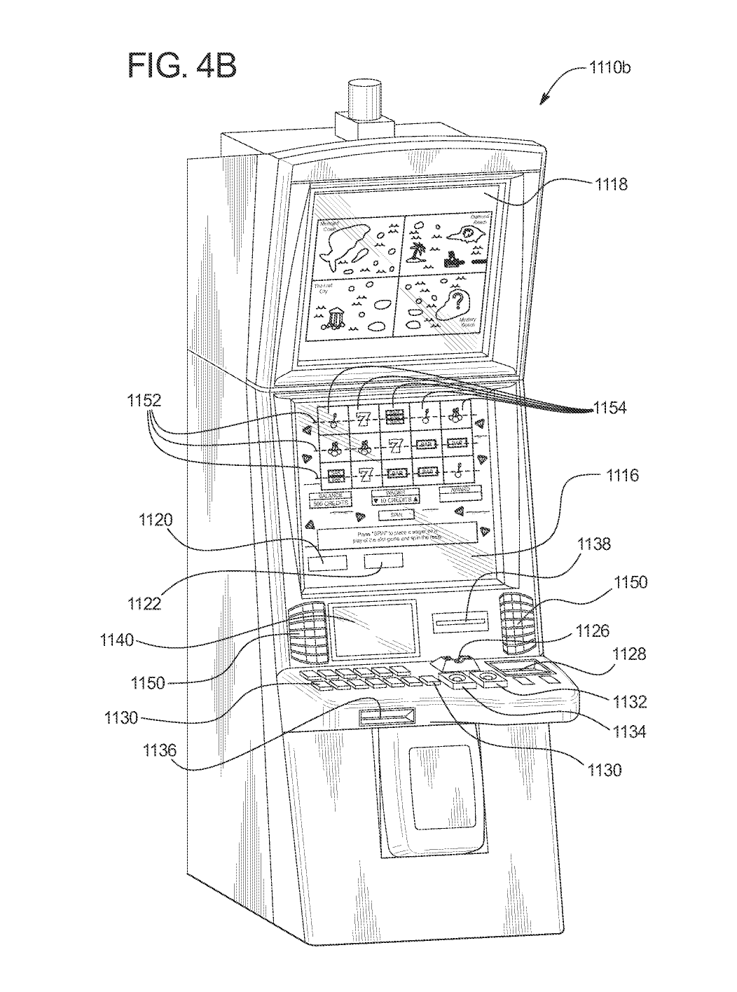

In various embodiments, the EGM includes one or more input devices. The input devices may include any suitable device that enables an input signal to be produced and received by the at least one processor of the EGM. The example EGM illustrated in FIG. 3B includes at least one input device 1030. One input device of the EGM is a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. FIGS. 4A and 4B illustrate example EGMs 1110a and 1110b that each include the following payment devices: (a) a combined bill and ticket acceptor 1128, and (b) a coin slot 1126.

In one embodiment, the EGM includes a payment device configured to enable the EGM to be funded via an electronic funds transfer, such as a transfer of funds from a bank account. In another embodiment, the EGM includes a payment device configured to communicate with a mobile device of a player, such as a cell phone, a radio frequency identification tag, or any other suitable wired or wireless device, to retrieve relevant information associated with that player to fund the EGM. It should be appreciated that when the EGM is funded, the at least one processor determines the amount of funds entered and displays the corresponding amount on a credit display or any other suitable display as described below.

In various embodiments, one or more input devices of the EGM are one or more game play activation devices that are each used to initiate a play of a game on the EGM or a sequence of events associated with the EGM following appropriate funding of the EGM. The example EGMs 1110a and 1110b illustrated in FIGS. 4A and 4B each include a game play activation device in the form of a game play initiation button 1132. It should be appreciated that, in other embodiments, the EGM begins game play automatically upon appropriate funding rather than upon utilization of the game play activation device.

In certain embodiments, one or more input devices of the EGM are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one. The example EGMs 1110a and 1110b illustrated in FIGS. 4A and 4B each include one or more input devices 1130.

In other embodiments, one input device of the EGM is a cash out device. The cash out device is utilized to receive a cash payment or any other suitable form of payment corresponding to a quantity of remaining credits of a credit display (as described below). The example EGMs 1110a and 1110b illustrated in FIGS. 4A and 4B each include a cash out device in the form of a cash out button 1134.

In certain embodiments, one input device of the EGM is a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In various embodiments, one input device of the EGM is a sensor, such as a camera, in communication with the at least one processor of the EGM (and controlled by the at least one processor of the EGM in some embodiments) and configured to acquire an image or a video of a player using the EGM and/or an image or a video of an area surrounding the EGM.

In embodiments including a player tracking system, as further described below, one input device of the EGM is a card reader in communication with the at least one processor of the EGM. The example EGMs 1110a and 1110b illustrated in FIGS. 4A and 4B each include a card reader 1138. The card reader is configured to read a player identification card inserted into the card reader.

In various embodiments, the EGM includes one or more output devices. The example EGM illustrated in FIG. 3B includes at least one output device 1060. One or more output devices of the EGM are one or more display devices configured to display any game(s) displayed by the EGM and any suitable information associated with such game(s). In certain embodiments, the display devices are connected to or mounted on a cabinet of the EGM (as described below). In various embodiments, the display devices serves as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 1110a illustrated in FIG. 4A includes a central display device 1116, a player tracking display 1140, a credit display 1120, and a bet display 1122. The example EGM 1110b illustrated in FIG. 4B includes a central display device 1116, an upper display device 1118, a player tracking display 1140, a credit display 1120, and a bet display 1122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, one output device of the EGM is a payout device. In these embodiments, when the cash out device is utilized as described above, the payout device causes a payout to be provided to the player. In one embodiment, the payout device is one or more of: (a) a ticket generator configured to generate and provide a ticket or credit slip representing a payout, wherein the ticket or credit slip may be redeemed via a cashier, a kiosk, or other suitable redemption system; (b) a note generator configured to provide paper currency; (c) a coin generator configured to provide coins or tokens in a coin payout tray; and (d) any suitable combination thereof. The example EGMs illustrated in FIGS. 4A and 4B each include ticket generator 1136. In one embodiment, the EGM includes a payout device configured to fund an electronically recordable identification card or smart card or a bank account via an electronic funds transfer.

In certain embodiments, one output device of the EGM is a sound generating device controlled by one or more sound cards. In one such embodiment, the sound generating device includes one or more speakers or other sound generating hardware and/or software for generating sounds, such as by playing music for any games or by playing music for other modes of the EGM, such as an attract mode. The example EGMs illustrated in FIGS. 4A and 4B each include a plurality of speakers 1150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels. SCSI ports, solenoids, speakers, thumbsticks, ticket readers, touch screens, trackballs, touchpads, wheels, and wireless communication devices. At least U.S. Patent Application Publication No. 2004/0254014 describes a variety of EGMs including one or more communication ports that enable the EGMs to communicate and operate with one or more external peripherals.

As generally described above, in certain embodiments, such as the example EGMs 1110a and 1110b illustrated in FIGS. 4A and 4B, the EGM has a support structure, housing, or cabinet that provides support for a plurality of the input device and the output devices of the EGM. Further, the EGM is configured such that a player may operate it while standing or sitting, in various embodiments, the EGM is positioned on a base or stand, or is configured as a pub-style tabletop game (not shown) that a player may operate typically while sitting. As illustrated by the different example EGMs 1110a and 1110b shown in FIGS. 4A and 4B, EGMs may have varying cabinet and display configurations.

It should be appreciated that, in certain embodiments, the EGM is a device that has obtained approval from a regulatory gaming commission, and in other embodiments, the EGM is a device that has not obtained approval from a regulatory gaming commission.

As explained above, for brevity and clarity, both the EGMs and the personal gaming devices of the present disclosure are collectively referred to herein as “EGMs.” Accordingly, it should be appreciated that certain of the example EGMs described above include certain elements that may not be included in all EGMs. For example, the payment device of a personal gaming device such as a mobile telephone may not include a coin acceptor, while in certain instances the payment device of an EGM located in a gaming establishment may include a coin acceptor.

Operation of Primary or Base Games and/or Secondary or Bonus Games

In various embodiments, an EGM may be implemented in one of a variety of different configurations. In various embodiments, the EGM may be implemented as one of: (a) a dedicated EGM wherein computerized game programs executable by the EGM for controlling any primary or base games (referred to herein as “primary games”) and/or any secondary or bonus games or other functions (referred to herein as “secondary games”) displayed by the EGM are provided with the EGM prior to delivery to a gaming establishment or prior to being provided to a player; and (b) a changeable EGM wherein computerized game programs executable by the EGM for controlling any primary games and/or secondary games displayed by the EGM are downloadable to the EGM through a data network or remote communication link after the EGM is physically located in a gaming establishment or after the EGM is provided to a player.

As generally explained above, in various embodiments in which the gaining system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award. At least U.S. Pat. Nos. 7,470,183; 7,563,163; and 7,833,092 and U.S. Patent Application Publication Nos. 2005/0148382, 2006/0094509, and 2009/0181743 describe various examples of this type of award determination.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards. At least U.S. Pat. Nos. 7,753,774; 7,731,581; 7,955,170; and 8,070,579 and U.S. Patent Application Publication No. 2011/0028201 describe various examples of this type of award determination.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host. In this embodiment, the accounting and gaming information system includes: (a) a player database for storing player profiles, (b) a player tracking module for tracking players (as described below), and (c) a credit system for providing automated transactions. At least U.S. Pat. No. 6,913,534 and U.S. Patent Application Publication No. 200610281541 describe various examples of such accounting systems.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGMs 1110a and 1110b shown in FIGS. 4A and 4B include a plurality of paylines 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. At least U.S. Pat. No. 8,012,011 and U.S. Patent Application Publication Nos. 2008/0108408 and 2008/0132320 describe various examples of ways to win award determinations.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award. At least U.S. Pat. Nos. 5,766,079; 7,585,223; 7,651,392; 7,666,093; 7,780,523; and 7,905,778 and U.S. Patent Application Publication Nos. 2008/0020846, 2009/0123364, 2009/0123363, and 2010/0227677 describe various examples of different progressive gaming systems.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). It should be appreciated that the secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. It should be appreciated that any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for the providing of the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, alter qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards. At least U.S. Patent Application Publication Nos. 2007/0123341, 2008/0070680, 2008/0176650, and 200910124363 describe various examples of different group gaming systems.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. At least U.S. Pat. Nos. 6,722,985; 6,908,387; 7,311,605; 7,611,411; 7,617,151; and 8,057,298 describe various examples of player tracking systems.

It should be understood that various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gaming system comprising:
at least one display device;
at least one input device;
at least one processor; and
at least one memory device that stores a plurality of instructions which, when executed by the at least one processor, cause the at least one processor to operate with the at least one display device and the at least one input device to:
(a) receive a wager on a play of a primary game, a current primary theme of said primary game being one of a plurality of different primary themes;
(b) display an outcome of said play of the primary game;
(c) determine any awards associated with the displayed outcome of said play of the primary game;
(d) display any determined awards associated with the displayed outcome of said play of the primary game;
(e) upon an occurrence of a first triggering event, for a secondary game including a plurality of different object visitation areas, each object visitation area being associated with: (i) one of the primary themes, and (ii) one of an unvisited status and a visited status:
(A) determine one of the object visitation areas based, at least in part, on the status of each of one or more of the object visitation areas, wherein for each of at least one of the object visitation areas, a probability of determining said object visitation area when said object visitation area has the unvisited status is greater than a probability of determining said object visitation area when said object visitation area has the visited status;
(B) display a secondary game object in association with said determined object visitation area;
(C) if said determined object visitation area has the unvisited status, change the status of said determined object visitation area to the visited status; and
(D) if the primary theme associated with said determined object visitation area is different than the current primary theme of said primary game, change the current primary theme of said primary game to the primary theme associated with said determined object visitation area; and
(f) upon an occurrence of a second different triggering event, for the secondary game:
(A) determine one of a plurality of different video segments based at least in part on: (i) the object visitation area that said secondary game object is displayed in association with; and (ii) at least one of any video segments previously displayed for the secondary game; and
(B) display the determined video segment.

2. The gaming system of claim 1, wherein the plurality of instructions, when executed by the at least one processor, cause the at least one processor to, upon the occurrence of the first triggering event:
(a) determine a subset of the object visitation areas; and
(b) determine one of the object visitation areas of the subset based, at least in part, on the status of each of one or more of the object visitation areas.

3. The gaming system of claim 1, wherein the subset of the object visitation areas includes one or more object visitation areas adjacent to the secondary game object.

4. The gaming system of claim 1, wherein the plurality of instructions, when executed by the at least one processor, cause the at least one processor to, upon the occurrence of the second triggering event, determine one of the plurality of different video segments based at least in part on a current narrative associated with the secondary game.

5. The gaming system of claim 1, wherein the plurality of instructions, when executed by the at least one processor, cause the at least one processor to, upon the occurrence of a third triggering event, the third triggering event being different than the first triggering event and the second triggering event:
(a) receive a selection associated with a direction;
(b) determine one of the object visitation areas based, at least in part, on the selected direction;
(c) display the secondary game object in association with said determined object visitation area;
(d) if said determined object visitation area has the unvisited status, change the status of said determined object visitation area to the visited status; and
(e) if the primary theme associated with said determined object visitation area is different than the current primary theme of said primary game, change the current primary theme of said primary game to the primary theme associated with said determined object visitation area.

6. A gaming system comprising:
at least one display device;
at least one input device;
at least one processor; and
at least one memory device that stores a plurality of instructions which, when executed by the at least one processor, cause the at least one processor to operate with the at least one display device and the at least one input device to:
(a) upon an occurrence of a first triggering event, for a secondary game:
(i) determine one of a plurality of different object visitation areas based, at least in part, on a status of each of one or more of the object visitation areas, wherein for each of at least one of the object visitation areas, a probability of determining said object visitation area when said object visitation area has a first status is greater than a probability of determining said object visitation area when said object visitation area has a second status; and
(ii) display a secondary game object in association with said determined object visitation area; and
(b) upon an occurrence of a second different triggering event, for the secondary game:
(i) determine one of a plurality of different video segments based at least in part on: (A) the object visitation area that said secondary game object is displayed in association with; and (B) at least one of any video segments previously displayed for the secondary game; and
display the determined video segment.

7. The gaming system of claim 6, wherein the plurality of instructions, when executed by the at least one processor, cause the at least one processor to, upon the occurrence of the first triggering event, for the secondary game, if said determined object visitation area has the first status, change the status of said determined object visitation area to the second status.

8. The gaming system of claim 6, wherein the plurality of instructions, when executed by the at least one processor, cause the at least one processor to, upon the occurrence of the first triggering event, for the secondary game, if a primary theme associated with said determined object visitation area is different than a current primary theme of a primary game, change the current primary theme of said primary game to the primary theme associated with said determined object visitation area.

9. A method of operating a gaming system, said method comprising:
(a) causing at least one processor to execute a plurality of instructions to operate with at least one input device to receive a wager on a play of a primary game, a current primary theme of said primary game being one of a plurality of different primary themes;
(b) causing the at least one processor to execute the plurality of instructions to operate with at least one display device to display an outcome of said play of the primary game;
(c) causing the at least one processor to execute the plurality of instructions to determine any awards associated with the displayed outcome of said play of the primary game;
(d) causing the at least one processor to execute the plurality of instructions to operate with the at least one display device to display any determined awards associated with the displayed outcome of said play of the primary game;
(e) upon an occurrence of a first triggering event, for a secondary game including a plurality of different object visitation areas, each object visitation area being associated with: (i) one of the primary themes, and (ii) one of an unvisited status and a visited status:
(A) causing the at least one processor to execute the plurality of instructions to determine one of the object visitation areas based, at least in part, on the status of each of one or more of the object visitation areas, wherein for each of at least one of the object visitation areas, a probability of determining said object visitation area when said object visitation area has the unvisited status is greater than a probability of determining said object visitation area when said object visitation area has the visited status;
(B) causing the at least one processor to execute the plurality of instructions to operate with the at least one display device to display a secondary game object in association with said determined object visitation area;
(C) if said determined object visitation area has the unvisited status, causing the at least one processor to execute the plurality of instructions to change the status of said determined object visitation area to the visited status; and
(D) if the primary theme associated with said determined object visitation area is different than the current primary theme of said primary game, causing the at least one processor to execute the plurality of instructions to change the current primary theme of said primary game to the primary theme associated with said determined object visitation area; and
(f) upon an occurrence of a second different triggering event, for the secondary game:
(A) causing the at least one processor to execute the plurality of instructions to determine one of a plurality of different video segments based at least in part on: (i) the object visitation area that said secondary game object is displayed in association with; and (ii) at least one of any video segments previously displayed for the secondary game; and
(B) causing the at least one processor to execute the plurality of instructions to operate with the at least one display device to display the determined video segment.

10. The method of claim 9, which includes causing the at least one processor to execute the plurality of instructions to, upon the occurrence of the first triggering event:
(a) determine a subset of the object visitation areas; and
(b) determine one of the object visitation areas of the subset based, at least in part, on the status of each of one or more of the object visitation areas.

11. The method of claim 9, wherein the subset of the object visitation areas includes one or more object visitation areas adjacent to the secondary game object.

12. The method of claim 9, which includes causing the at least one processor to execute the plurality of instructions to, upon the occurrence of the second triggering event, determine one of the plurality of different video segments based at least in part on a current narrative associated with the secondary game.

13. The method of claim 9, which includes causing the at least one processor to execute the plurality of instructions to, upon the occurrence of a third triggering event, the third triggering event being different than the first triggering event and the second triggering event:
(a) operate with the at least one input device to receive a selection associated with a direction;
(b) determine one of the object visitation areas based, at least in part, on the selected direction;
(c) operate with the at least one display device to display the secondary game object in association with said determined object visitation area;
(d) if said determined object visitation area has the unvisited status, change the status of said determined object visitation area to the visited status; and
(e) if the primary theme associated with said determined object visitation area is different than the current primary theme of said primary game, change the current primary theme of said primary game to the primary theme associated with said determined object visitation area.

14. The method of claim 9, which is provided through a data network.

15. The method of claim 14, wherein the data network is an internet.

16. A method of operating a gaming system, said method comprising:
(a) upon an occurrence of a first triggering event, for a secondary game:
(i) causing the at least one processor to execute the plurality of instructions to determine one of a plurality of different object visitation areas based, at least in part, on a status of each of one or more of the object visitation areas, wherein for each of at least one of the object visitation areas, a probability of determining said object visitation area when said object visitation area has a first status is greater than a probability of determining said object visitation area when said object visitation area has a second status; and
(ii) causing the at least one processor to execute the plurality of instructions to operate with at least one display device to display a secondary game object in association with said determined object visitation area; and
(b) upon an occurrence of a second different triggering event, for the secondary game:
(i) causing the at least one processor to execute the plurality of instructions to determine one of a plurality of different video segments based at least in part on: (A) the object visitation area that said secondary game object is displayed in association with; and (B) at least one of any video segments previously displayed for the secondary game; and
(ii) causing the at least one processor to execute the plurality of instructions to operate with the at least one display device to display the determined video segment.

17. The method of claim 16, which includes causing the at least one processor to execute the plurality of instructions to, upon the occurrence of the first triggering event, for the secondary game, if said determined object visitation area has the first status, change the status of said determined object visitation area to the second status.

18. The method of claim 16, which includes causing the at least one processor to execute the plurality of instructions to, upon the occurrence of the first triggering event, for the secondary game, if a primary theme associated with said determined object visitation area is different than a current primary theme of a primary game, change the current primary theme of said primary game to the primary theme associated with said determined object visitation area.

19. The method of claim 16, which is provided through a data network.

20. The method of claim 19, wherein the data network is an internet.
